(19) United States
(12) Patent Application Publication
(10) Pub. No.: US 2025/0370672 A1
(43) Pub. Date: Dec. 4, 2025

(54) CONTROL METHOD, INFORMATION PROCESSING APPARATUS, AND COMPUTER-READABLE STORAGE MEDIUM STORING PROGRAM

(71) Applicant: CANON KABUSHIKI KAISHA, Tokyo (JP)

(72) Inventor: YU MATSUMOTO, Kanagawa (JP)

(21) Appl. No.: 19/219,141

(22) Filed: May 27, 2025

(30) Foreign Application Priority Data
May 29, 2024 (JP) 2024-087248

(51) Int. Cl. G06F 3/12; H04W 76/10

(52) U.S. Cl. CPC G06F 3/1236; G06F 3/1204; G06F 3/1288; H04W 76/10

(57) ABSTRACT

A control method for an information processing apparatus including a predetermined application program is provided. The control method includes first processing and second processing being executed by the predetermined application program, control being performed so that first search processing for searching for a communication apparatus corresponding to a transmission destination of connection information to the communication apparatus for connecting to an external access point on a predetermined network that the information processing apparatus belongs to and confirmation processing for confirming whether or not the information processing apparatus belonging to the predetermined network is connected to an internet are executed by the information processing apparatus in parallel.

### BACKGROUND

### Field of the Technology

The present disclosure relates to a control method for an information processing apparatus, an information processing apparatus, and a computer-readable storage medium storing a program.

### Description of the Related Art

A plurality of information processing apparatuses such as personal computers (PCs) sharing a device such as a printer functioning as a communication device via a local area network (LAN) connected to the Internet is known. Also, the LAN may be constructed of a wireless network, and in this case, the user-friendliness is improved over a wired network due to the devices not needing a specific installation place.

As described in Japanese Patent Laid-Open No. 2018-191252, in order for a printer to easily join an already constructed LAN, a PC and a printer temporarily connect via a wireless direct connection to easily connect the printer to an access point (AP). In other words, the PC transmits the information for connecting to a specific AP to the printer via a wireless direct communication. Also, on the PC, the user is made to designate the AP settings information for the AP the user wishes to connect the printer to (hereinafter, also referred to as user-desired AP) including a service set identifier (SSID), a password, and the like. As described in Japanese Patent Laid-Open No. 2020-88428, to enable a communication between a printer and a PC connected to different LANs, the PC is automatically connected to the same network as the printer.

### SUMMARY

Embodiments of the present disclosure provide a control method for an information processing apparatus including a predetermined application program, the control method comprising: transmitting connection information to a communication apparatus for connecting to an external access point; executing first processing that is processing for causing the information processing apparatus to execute first search processing for searching for the communication apparatus corresponding to a transmission destination of the connection information on a predetermined network that the information processing apparatus belongs to, and is processing executed by the predetermined application program in a state in which the information processing apparatus belongs to the predetermined network; and executing second processing that is processing for causing the information processing apparatus to execute confirmation processing for confirming whether or not the information processing apparatus belonging to the predetermined network is connected to an Internet, and is processing executed by the predetermined application program in a state in which the information processing apparatus belongs to the predetermined network, wherein by the first processing and the second processing being executed by the predetermined application program, control is performed so that the first search processing and the confirmation processing are executed by the information processing apparatus in parallel.

Embodiments of the present disclosure enable realization of further enhancement of user-friendliness regarding processing for enabling communication via a network between a communication apparatus and an information processing apparatus.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams illustrating a system configuration.

FIG. 2 is a diagram illustrating a hardware configuration of an information processing apparatus and a communication apparatus.

FIG. 3 is a flowchart illustrating the processing in the information processing apparatus.

FIG. 4 is a diagram illustrating a user interface screen.

FIG. 5 is a flowchart illustrating the processing in the communication apparatus.

FIG. 6 is a flowchart illustrating the processing in the information processing apparatus.

FIG. 7 is a diagram illustrating a user interface screen.

FIGS. 8A to 8C are diagrams illustrating user interface screens.

FIG. 9 is a flowchart illustrating the processing in the information processing apparatus.

FIGS. 10A and 10B are diagrams illustrating a user interface screen.

FIGS. 11A and 11B are flowcharts illustrating the processing in the information processing apparatus.

FIG. 12 is a diagram illustrating a user interface screen.

FIGS. 13A and 13B are flowcharts illustrating the processing in the information processing apparatus.

FIG. 14 is a diagram illustrating a user interface screen.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

There is a demand for further enhancement of user-friendliness regarding processing for enabling communication via a network between a communication apparatus and an information processing apparatus.

The present disclosure enables realization of further enhancement of user-friendliness regarding processing for enabling communication via a network between a communication apparatus and an information processing apparatus.

### First Embodiment

In the present embodiment, a system including an information processing apparatus and a communication apparatus will be described. A printer is used as an example of the communication apparatus in the description. However, a PC, tablet terminal, smartphone, camera, smart speaker, scanner, or the like may be used. Also, a PC is used as an example of the information processing apparatus in the description. However, a smartphone, tablet terminal, or the like may be used. In the present embodiment, it is expected that the PC executes the processing for connecting the printer to an already constructed LAN. Such processing may be referred to as network setup and includes the following operations.

For the PC and the printer to establish a wireless infrastructure connection and communicate with one another, a network setup instruction is transmitted from the PC to the printer. A wireless infrastructure connection is a connection via an AP, such as when the PC and the printer connect to the same AP and communicate, for example. The AP is included in a wireless LAN router, for example. With a printer without an independent display device, it is not easy for a user to input an SSID and password for connecting the printer to the AP without making a mistake. Regarding this, the PC can temporarily connect to the printer in a network setup mode (described below), transmit, to the printer, information such as the SSID, password, and the like relating to the AP the user wishes to connect the printer to, and connect the printer to the AP. For example, the PC obtains a list of APs that the printer can connect to from the printer. Then, in a case where the AP which the PC was connected to is included in the list, the PC transmits, to the print, settings information of the AP the PC was connected to. Then, the printer uses the AP settings information received from the PC to connect to the AP. In such processing, since the user does not need to operate the printer or the AP, the user can easily perform network setup for the printer.

As described above, the AP settings information may include AP identifying information such as an SSID and authentication information used in AP authentication processing such as a password. In other words, the AP settings information is AP network information. The operating system (OS) of the PC stores the AP settings information as a wireless profile when the AP and the PC connect via a wireless LAN interface. Here, a wireless profile is information including the SSID of the AP that the wireless LAN interface is connected to, authentication information (password or the like) used in authentication processing, and the like. The wireless profile is stored and managed by the OS. Thus, the AP settings information transmitted from the PC to the printer may be obtained from the wireless profile stored in the OS.

For example, take an example in which the PC is connected to an AP designating an SSID for a 5 GHz frequency band and the printer supports only wireless LAN communication at a 2.4 GHz frequency band. In such a case, the user would perform a network setup to connect the printer to the network of the user-desired AP. At this time, the wireless profile of an AP with an SSID for a 5 GHz frequency band is stored in the OS of the PC. However, a wireless profile of an AP with an SSID for a 2.4 GHz frequency band connectable by the printer is not stored in the OS. Thus, for the AP with an SSID for a 2.4 GHz frequency band, the user needs to be made to designate on the PC the AP settings information such as the SSID, password, and the like. Then, in the network setup, the AP settings information designated by the user is transmitted to the printer. In this manner, the AP settings information transmitted to the printer in the network setup is not always the same as the settings information of the AP that the PC was connected to.

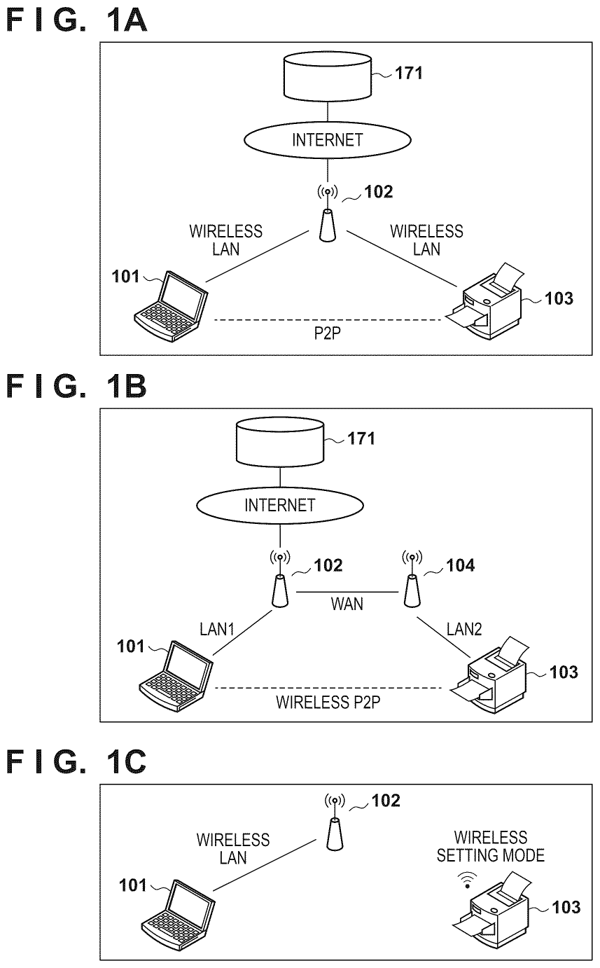

A case where one wireless LAN router supports a plurality of frequency bands means that the one wireless LAN router is a plurality of APs supporting different frequency bands and that the plurality of APs with different SSIDs are activated. Some wireless LAN routers have a security function that cuts off communication by stopping communication between devices connected using different SSIDs even if the devices are connected to the same wireless LAN router. In other words, in a case where the one wireless LAN router is activating an AP that supports 2.4 GHZ and an AP that supports 5 GHz, if the security function is enabled, control is performed to stop communication between the device connected to the AP supporting 2.4 GHz and the device connected to the AP supporting 5 GHz. Such a function is called an SSID separation function. In a case where the SSID separation function in a wireless LAN router including a plurality of SSIDs (a first SSID and a second SSID) is enabled and the PC is connected to the AP using the first SSID, communication cannot be performed with the printer connected to an AP using the second SSID. Also, as illustrated in FIG. 1B and described below, in a case where the SSID used by the PC to connect and the SSID used by the printer to connect are different, both devices cannot always connect to the same wireless LAN router. In a configuration in which the PC and the printer connect to different wireless LAN routers, the PC may be unable to communicate with the printer. In such a case where the PC and the printer cannot communicate, the PC cannot discover the printer on the network by searching. As a result, the PC cannot register the printer information in an application program (hereinafter simply referred to as an application) on the PC and cannot execute the printer function via the network using the application.

However, in a case where the PC and the printer described above cannot communicate, for example, by changing the connection destination of the PC to the same AP as the printer, the PC may be able to communicate with the printer. However, the settings of the AP that the PC was originally connected to may not be the same as the settings of the AP that the printer is connected to. For example, the AP that the printer is connected to may be restricted in its Internet connection. Thus, the PC changes the PC connection destination to the same AP as the printer and executes processing to search for the printer via the network of the AP. Also, in the network setup, for example, an Internet connection may be required for processing to obtain a printer driver from an external server as described below. Thus, to establish communication between the PC and the printer, in the case of changing the connection destination of the PC to the same AP as the printer, whether or not the PC can form an Internet connection via the same AP as the printer needs to be confirmed. Specifically, for example, in the state after the connection destination of the PC has been changed to the same AP as the printer, whether or not the PC is connected to the Internet needs to be confirmed. A method of confirming whether the PC is connected to the Internet includes, for example, using a standard application programming interface (API) provided by the OS of the PC (hereinafter referred to as an OS-standard API). In the OS-standard API, there is an API for obtaining the Internet connection status of the PC, for example. Then, by referencing a result obtained by execution of the API, whether or not the PC is in an Internet-connected state can be determined. However, depending on the OS of the PC, the OS may not include an OS-standard API for determining whether or not the PC is connected to the Internet. In such cases, for example, the PC needs to execute processing to use an OS API for attempting to download a specific file and confirm whether or not the PC is connected to the Internet on the basis of the attempt result. Note that this processing may have a timeout time set, with a default timeout time of one minute, for example. In the processing with a timeout time set, for example, if the PC is in an environment in which it belongs to a network but cannot connect to the Internet, download is attempted until the download timeout time is reached. Thus, the processing for confirming whether or not the PC is connected to the Internet takes time. Also, in a case where the processing to confirm Internet connection and the processing to search for the printer described above are executed in order, both of these items of processing take time.

Regarding this, in the present embodiment, by the PC transmitting AP settings information to the printer, control can be performed that is appropriate for a case in which the PC cannot communicate with a printer even though the printer and the AP are connected. Specifically, in the present embodiment, in a case where the PC cannot discover a printer via the network of the AP that the PC was originally connected to, the connection is temporarily changed to the network of the AP that the printer is connected to. Next, searching for the printer via the network of the AP that the printer is connected to and confirming whether or not there is an Internet connection are performed in parallel. Then, in a case where the search for the printer is successful and the PC is connected to the Internet, the PC displays a confirmation screen to the user. On the basis of a user instruction on the confirmation screen, control is then performed to set the connection destination network of the PC to the same network as the printer. In this manner, control is performed to set the connection destination network of the PC to the network that the printer is connected to only in a case where the user determines that it is ok to change the connection destination network of the PC. This can prevent a situation in which communication with the printer is unable to be performed as a result of the connection destination network of the PC being automatically switched despite the intentions of the user. In other words, control is performed so that the connection destination network of the PC is not automatically switched despite the intentions of the user. Thus, the user does not have to go to the trouble of returning the PC to the original connection destination network when communication is disconnected with another device that it had been communicating with due to the connection destination of the PC being automatically switched. This improves user-friendliness. Also, since searching for the printer and confirming whether or not the PC is connected to the Internet are performed in parallel, processing can be executed in a time-efficient manner.

FIGS. 1A to 1C are diagrams illustrating the system configuration according to the present embodiment. FIG. 1A illustrates a state in which a PC 101 and an AP 102 are connected via a wireless LAN. Also, a printer 103 is connected to the AP 102 via a wireless LAN. In other words, the PC 101 is in a state in which it can communicate with the printer 103 and the AP 102, and a wireless infrastructure connection is established. In the wireless infrastructure connection, a network environment in which the PC 101 can communicate with two or more devices can be constructed. Note that if the printer 103 and the AP 102 are in a state of being connected via the wireless LAN and the PC 101 and the printer 103 are in a state in which it can communicate via the AP 102, the printer 103 may be said to have established a wireless infrastructure connection. In other words, in FIG. 1A, the PC 101 may be in a state of being connected to the AP 102 via a wired LAN. Also, an external server 171 is a server that can provide a service to apparatuses connected to the AP 102 via the Internet. For example, the external server 171 is a server that enables the PC 101 to download a printer driver for the printer 103. In FIG. 1A, the LAN formed by the AP 102 includes the AP 102, the printer 103, and the PC 101. A wide area network (WAN) includes the AP 102 and the external server 171.

FIG. 1B illustrates a configuration in which an AP 104 is connected to the AP 102 via a WAN. Typically, the AP 104 preferably connects to the AP 102 via LAN, the LAN of the AP 102 and the WAN of the AP 104 may connect and construct a network despite the intentions of the user. In this case, a LAN 2 formed by the AP 104 becomes a network different from a LAN 1, and the PC 101 connected via the LAN 1 and the printer 103 connected via the LAN 2 may be unable to communicate with one another. Note that the AP 104 is connected to the AP 102 via a WAN and thus can access the external server 171. In other words, the printer 103 connected to the LAN 2 formed by the AP 104 can access the external server 171.

A connection method known as wireless direct connection enables only two devices to communicate with one another. The PC 101 and the printer 103 can form a peer to peer connection (hereinafter referred to as P2P connection) via the wireless direct connection. However, during a P2P connection, the PC 101 and the printer 103 also use the internal wireless LAN interfaces via the P2P connection and thus may become unable to communicate with other devices. Accordingly, the P2P connection is often used as a temporary connection. In the present embodiment, the PC 101 executes network setup processing (P2P wireless settings processing) for connecting the printer 103 to the AP 102 or the AP 104 via a wireless LAN connection. Specifically, the PC 101 connects the printer 103 to the AP 102 (or the AP 104) by transmitting the settings information of the AP 102 (or the AP 104) to the printer 103 via a P2P connection. In the network setup processing, the PC 101 transmits the settings information of the AP 102 (or the AP 104) of the printer 103 using a P2P connection. In the present embodiment, a state in which the printer 103 can receive a network setup instruction including the AP settings information is defined as a “network setup mode”. FIG. 1C will be described below.

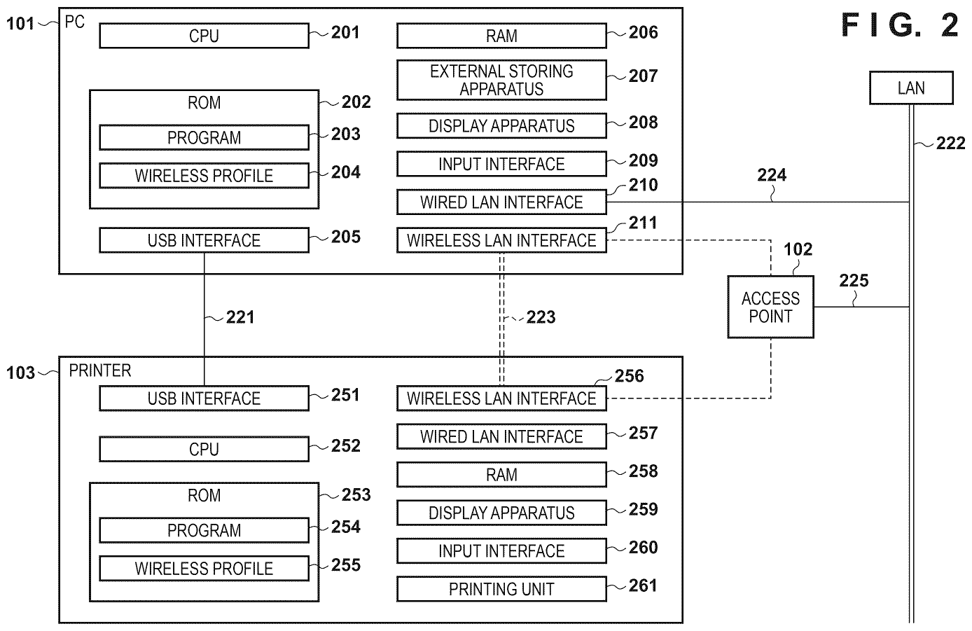

FIG. 2 is a diagram illustrating the hardware configuration of a communication system including the PC 101 and the printer 103 according to the present embodiment. The PC 101 includes a CPU 201, a ROM 202, a RAM 206, an external storage apparatus 207, a display apparatus 208, and an input interface 209. The CPU 201 forms the computer of the PC 101 that executes programs using the ROM 202, the RAM 206, and the like. Also, the PC 101 includes a universal serial bus (USB) interface 205, a wired LAN interface 210, and a wireless LAN interface 211. The PC 101 is not limited to the configuration illustrated in FIG. 2 and may include as appropriate a functional block that can be executed by a device used as the PC 101.

The CPU 201 is a processor that reads out and executes a control program stored in the ROM 202 and both controls the entire PC 101 via the control program and executes the processing illustrated in the flowcharts described below. Also, as a result of execution of the control program, various types of functions of the PC 101 are implemented, such as control of communication with external devices such as the printer 103, generation of print jobs to be output to the printer 103, network setup instructions, and the like.

The RAM 206 is configured of a DRAM, SRAM, or the like that requires a backup power source and is used as the memory area that temporarily stores settings information, management data, and the like when the PC 101 is operating. Also, the RAM 206 may be used as a main memory of the CPU 201, a working area, or a similar temporary storage area and may be used as a transmission buffer or the like for temporarily storing a generated print job to be transmitted to the printer 103.

The ROM 202 stores a program 203 corresponding to various types of processing including a program for network setup processing for transmitting AP settings information to the printer 103, a wireless profile 204 described below, and the like. The network setup processing will be described below in detail.

Also, in the external storage apparatus 207, an operating system (OS), a printer driver, and various other types of data are stored. Note that in the present embodiment, the OS stored by the external storage apparatus 207 and operating on the PC 101 is mac OS (registered trademark) provided by Apple Inc. Note that the OS operating on the PC 101 is not limited to this, and an OS other than mac OS may be used. The OS may be Windows (registered trademark) provided by Microsoft Corporation, for example. The display apparatus 208 is constituted by a light-emitting diode (LED), a liquid crystal display (LCD), and/or the like and displays various types of user interface screens for the OS and the program 203 and provides notifications relating to the state of the PC 101.

The input interface 209 is an interface for receiving data input and user instruction operations from the user via operation of an operation unit such as a keyboard. Note that the operation unit may be a physical keyboard, a physical button, or the like or may be a software keyboard, software button, or the like displayed on the display apparatus 208. In other words, the input interface 209 may receive input from the user via the display apparatus 208.

The program for network setup processing may be an application program for connection settings for the AP 102 that the printer 103 is to be connected to and may be provided with other functions other than the network setup function. The program for network setup processing may hereinafter also referred to as an application for setup. For example, the application for setup may have a function for causing the printer 103 to print, a function for causing the printer 103 to scan a set document, a function for confirming the state of the printer 103, and the like. Also, the application for setup may have a function for transmitting the information obtained from the printer 103, personal information of the user obtained by the PC 101, and the like to a service management server (not illustrated). The external server 171 may correspond to such a service management server. The application for setup, for example, is stored in the ROM 202 by being downloaded from the external server 171 via Internet communication using the wireless LAN interface 211 and installed.

Also, the ROM 202 stores network information. Network information includes IP addresses allocated to the wireless LAN interface 211 and the wired LAN interface 210 of the PC 101 and the IP address and subnet mask of the AP the PC 101 is currently connected to. Also, the network information stores the wireless profiles of APs that the PC 101 has connected to. In other words, the ROM 202 stores the history information of APs that the PC 101 has previously connected to. A wireless profile includes, as information, SSIDs, security settings, and passwords of APs that the PC 101 has connected to.

The wired LAN interface 210 and the wireless LAN interface 211 are configured to connect to an external apparatus such as the printer 103 or the AP 102 and execute data communication. For example, the wireless LAN interface 211 can connect to an AP (not illustrated) inside the printer 103. The AP inside the printer 103 will be described below.

The wireless LAN interface 211 controls the exchange of data compliant with a communication standard specified in IEEE 802.11 according to an instruction from the CPU 201. The wireless communication system used here, for example, is as specified as wireless fidelity (Wi-Fi) (registered trademark) by the Wi-Fi Alliance and is defined as a wireless LAN standard. Also, the wireless LAN interface 211 includes an AP, as the AP inside the PC 101, for connecting to an apparatus such as the printer 103. The AP inside the PC 101 is typically referred to as tethering. Also, in a case where the wireless LAN interface 211 of the PC 101 is connected to the Internet, the printer 103 can also be connected to the Internet via the wireless LAN interface 211.

The PC 101 can form a P2P connection (direct connection) with the printer 103 via a USB cable 221 or a wireless direct connection 223 using the wireless LAN interface 211. Also, the PC 101 can connect to a LAN 222 from the wired LAN interface 210 via an Ethernet cable 224. In this case, if the printer 103 can also be connected to the LAN 222 via the AP 102 or the like, then the PC 101 and the printer 103 can communicate with one another in the same LAN 222 environment. Furthermore, by connecting the PC 101 to the AP 102 via the wireless LAN interface 211 and connecting the AP 102 to the LAN 222 via an Ethernet cable 225, the PC 101 can connect to the LAN 222. Also, if the printer 103 can also connect to the AP 102, then the PC 101 and the printer 103 can communicate with one another via the AP 102.

The printer 103 includes a CPU 252, a ROM 253, a RAM 258, a display apparatus 259, an input interface 260, a USB interface 251, a wireless LAN interface 256, and a wired LAN interface 257. The computer of the printer 103 that executes programs is formed by the CPU 252, the ROM 253, the RAM 258, and the like. The printer 103 is not limited to the configuration illustrated in FIG. 2 and may include as appropriate a functional block that can be executed by a device (for example, a multi-function printer) used as the printer 103.

The CPU 252 is a processor that reads out and executes a control program stored in the ROM 253 and both controls the entire printer 103 via the control program and executes the processing illustrated in the flowcharts described below. As a result of the execution of the control program, various types of functions of the printer 103 are implemented, such as control of communication with external apparatuses such as the PC 101.

The RAM 258 is configured of a DRAM, SRAM, or the like that requires a backup power source and is used as the memory area that temporarily stores settings information, management data, and the like when the printer 103 is operating. Furthermore, the RAM 258 is used as a main memory of the CPU 252, a working area, or a similar temporary storage area and may operate as a receiving buffer for temporarily storing printing information received from the PC 101 or the like.

The ROM 253 is non-volatile flash memory for storing fixed data such as a control program executed by the CPU 252, data tables, an embedded OS, and the like. In the present embodiment, the respective control programs stored in the ROM 253 control the execution of software, such as scheduling, task switching, and interrupt processing, under the management of the built-in OS stored in the ROM 253. The ROM 253 stores a program 254, a wireless profile 255, and the like. Here, the wireless profile 255 is information including the SSID of the AP that the wireless LAN interface 256 is connected to, authentication information (password or the like), and the like. The wireless profile 255 is stored and managed in the ROM 253 by the CPU 252 executing the program 254 included in the ROM 253. For example, when the printer 103 is powered on, the printer 103 can reconnected to the network it was previously connected using the wireless profile 255. Furthermore, for example, the printer 103 may be configured to manage a plurality of wireless profiles as with the OS of the PC 101.

Also, the ROM 253 stores a unique SSID uniquely set for the printer 103. Here, a unique SSID is uniquely set for the printer manufacturer and the printer type, and the wireless LAN interface 256 of the printer 103 can operate as the AP corresponding to the unique SSID. Thus, as when connecting to the AP 102, the PC 101 can connect via the printer 103 operating as the AP corresponding to the unique SSID and the wireless direct connection 223.

The display apparatus 259 is constituted by a light-emitting diode (LED), a liquid crystal display (LCD), or the like and displays various types of menus and provides notifications relating to the state of the printer 103. The input interface 260 is an interface for receiving data input and user instruction operations from the user via operation of an operation unit such as a keyboard. Note that the operation unit may be a physical keyboard, a physical button, or the like or may be a software keyboard, software button, or the like displayed on the display apparatus 259. In other words, the input interface 260 may receive input from the user via the display apparatus 259.

A printing unit 261 discharges a printing agent such as ink on a print medium such as cut paper on the basis of image data to form an image on the print medium and output a printing result. Also, the printing unit 261 is configured to execute initial installation processing including print head cleaning and registration adjustment for adjusting the ink discharge position in a case where it is determined that a power-on is a power-on at the time of shipment. Note that the printing unit 261 is not necessarily only an inkjet printing system, and an electro-photographic system or other printing system may be used.

The printer 103 can perform P2P communication with the PC 101 via the USB cable 221 or via the wireless direct connection 223. Also, by connecting the printer 103 to the AP 102 via the wireless LAN interface 256 and connecting the AP 102 to the LAN 222 via an Ethernet cable 225, the printer 103 can connect to the LAN 222. In the example described using FIG. 2, the PC 101 and the printer 103 share the processing as described above, but a different sharing configuration may be used.

The mode for executing wireless communication using a wireless LAN interface and a connection system will be described below.

### Direct Connection System

Direct connection means a mode of direct, wireless connection between apparatuses bypassing an external apparatus such as the AP 102. Direct connection may also be referred to as peer to peer connection (P2P connection). The printer 103 can operate in a mode (direct connection mode) for communicating by direct connection, which is one example of a connection mode. In Wi-Fi communication, modes for communicating via direct connection include a plurality of modes such as a software AP mode, a Wi-Fi Direct (WFD) mode, and the like.

A mode in which direct connection is executed via WFD is referred to as a WFD mode. WFD is a standard established by the Wi-Fi Alliance and is included in the IEEE 802.11 series communication standards. In the WFD mode, after a communication partner device is searched for via a device search command, the role of the P2P group owner (GO) and the P2P client are determined, before the remaining wireless connection processing is executed. The group owner corresponds to the Wi-Fi master station (master unit), and the client corresponds to the Wi-Fi slave station (slave device). Note that a master station is an apparatus that constructs a wireless network and an apparatus that provides a parameter used in connecting to the wireless network to the slave station. The parameter used in connecting to the wireless network is a parameter relating to a channel used by the master station, for example. The slave station receives the parameter and uses the channel used by the master station to connect to the wireless network constructed by the master station. The role determination is referred to as GO negotiation. Note that in the WFD mode in a state before role determination has been performed, the printer 103 is in a state without a master station or a slave station. Specifically, between devices to communicate, first one device issues a device search command and searches for a device to connect to via the WFD mode. When another device corresponding to a communication partner is searched for, before the devices, information relating to services and functions that each can provide is confirmed. Note that the device provision information confirmation is optional and not required. The device provision information confirmation phase corresponds to a P2P provision discovery, for example. Next, the device provision information of each are confirmed, and it is determined which is to be the P2P client and which is to be the P2P group owner. When the client and the group owner are determined, the devices exchange parameters for communicating via WFD. On the basis of the exchanged parameters, the remaining wireless connection processing and IP connection processing are executed between the client and the group owner. Note that in the WFD mode, the printer 103 may not execute the GO negotiation described above and may always operate as the GO. In other words, the printer 103 may operate in a WFD mode which is an autonomous GO mode. Also, the state in which the printer 103 is operating in the WFD mode, for example, is a state in which a connection via WFD has not been established but the printer 103 is operating as the GO or a state in which a connection via WFD has been established and the printer 103 is operating as the GO.

In the software AP mode, of the devices communicating (for example, the PC 101 and the printer 103), one of the devices (for example, the PC 101) takes the role of the client that requests various types of services. Also, the other device implements the function of the AP in Wi-Fi via the software settings. The software AP corresponds to the Wi-Fi master station, and the client corresponds to the Wi-Fi slave station. In the software AP mode, the client searches for a device to be the software AP via a device search command. When a software AP is searched for, the remaining wireless connection processing (wireless connection establishment and the like) between the client and the software AP is executed. Thereafter, IP connection processing (IP address allocation and the like) is executed. Note that the commands and parameters transmitted and received when establishing a wireless connection between the client and the software AP are as specified in Wi-Fi standards, and thus description thereof will be omitted.

In the present embodiment, in a case where the printer 103 establishes and maintains a direct connection, the printer 103 operates as the master station in the network that the printer 103 belongs to. Thus, the printer 103 can determine which frequency band to use in communication in the direct connection mode and which channel to use. In the present embodiment, the printer 103 can use a channel corresponding to a 2.4 GHz frequency band and a channel corresponding to a 5 GHz frequency band in communication in the direct connection mode.

### Infrastructure Connection Method

Infrastructure connection is a mode of connection for connecting to an AP (for example, the AP 102) controlling the network of devices to communicate (for example, the PC 101 and the printer 103) and for the devices to communicate via the AP. The printer 103 can operate in a mode (infrastructure connection mode) for communicating via an infrastructure connection, which is one example of a connection mode.

In an infrastructure connection, the devices search for an AP via a device search command. When an AP is searched for, the remaining wireless connection processing (wireless connection establishment and the like) between the devices is executed. Thereafter, IP connection processing (IP address allocation and the like) is executed. Note that the commands and parameters transmitted and received when establishing a wireless connection between the devices and the AP are as specified in Wi-Fi standards, and thus description thereof will be omitted.

In the present embodiment, when the printer 103 operates in the infrastructure connection, the AP 102 operates as the master station and the printer 103 operates as the slave station. In other words, in the present embodiment, infrastructure connection refers to a connection between the printer 103 operating as the slave station and the AP 102 operating as the master station. In a case where the printer 103 establishes an infrastructure connection and an infrastructure connection between the PC 101 and the AP 102 is also established, communication between the printer 103 and the PC 101 can be performed via the AP 102. The channel to use in communication with an infrastructure connection is determined by the AP 102, and the printer 103 executes communication with an infrastructure connection using the channel determined by the AP 102. In the present embodiment, the printer 103 can use a channel corresponding to a 2.4 GHz frequency band and a channel corresponding to a 5 GHz frequency band in communication with the infrastructure connection. Note that the printer 103 can also use, in the communication with the infrastructure connection, a channel corresponding to a dynamic frequency selection (DFS) band from among the 5 GHz frequency band. Note that in order to communicate with the printer 103 via the AP 102, the PC 101 needs to recognize (search and discover) the printer 103 on the network formed by the AP 102 that the PC 101 belongs to.

### Network Setup Mode

The printer 103 can operate in the network setup mode. The trigger for starting the printer 103 operating in the network setup mode may be, for example, the user pressing a button for network setup mode or the printer 103 being activated (powered on) for the first time after shipment. A button for network setup mode may be a hard (physical) button provided on the printer 103 or may be a software button displayed on the display apparatus 259 by the printer 103.

The printer 103 activates Wi-Fi communication when operation in the network setup mode is started. Specifically, the printer 103 activates the AP (AP for setup) inside the printer 103 dedicated to the network setup mode as Wi-Fi communication activation processing. The SSID of the AP for setup corresponds to the unique SSID described above. Accordingly, the printer 103 is put in a state where a direct connection can be established with the PC 101 via Wi-Fi. The connection information (SSID) for connecting to the AP for setup is stored in advance in the application for setup (the program 203) installed on the PC 101, and the PC 101 recognizes in advance the connection information for connecting to the AP for setup. Thus, different from the connection information of the AP activated in the direct connection mode, the connection information for connecting to the AP for setup cannot be discretionarily changed by the user. Note that in the network setup mode, the printer 103 may connect to the PC 101 via Wi-Fi Direct (WFD) instead of normal Wi-Fi. In other words, the printer 103 may operate as a group owner and receive network information from the PC 101 via WFD communication. Also, in the network setup mode, the printer 103 may connect to the PC 101 via Bluetooth. Here, Bluetooth includes Bluetooth Classic and Bluetooth Low Energy (BLE). In other words, for example, the printer 103 may operate as a slave apparatus in BLE in the network setup mode and receive the network information from the PC 101 via BLE communication. Also, in the network setup mode, the printer 103 may be able to perform both network setup via Wi-Fi and network setup via BLE. In other words, the printer 103 may activate both Wi-Fi communication and BLE communication when operation in the network setup mode is started. Specifically, when operation in the network setup mode is started, the printer 103 may activate both the AP for setup and an advertising state in which advertising information can be transmitted via BLE enabling a BLE connection. Also, the printer 103 may receive the network information from the PC 101 via a wired LAN or USB.

As described above, the printer 103 operates in the network setup mode for performing network setup of the printer 103 according to a predetermined condition including the user pressing a button or the time of initial installation. In a case where the printer 103 operates in the network setup mode, the printer 103 controls the wireless LAN interface 256 and operates as an AP for setup activated only during operation in the network setup mode. The AP for setup is an AP that is different from the AP activated when in the software AP mode described above. The SSID of the AP for setup includes a predetermined character string that is recognizable by the application for setup (the program 203) of the PC 101.

Also, the printer 103 operating in the network setup mode uses a predetermined communication protocol (communication protocol for setup) in the communications with the PC 101 connected to the AP for setup. The communication protocol for setup is specifically the simple network management protocol (SNMP), for example.

After operation in the network setup mode has started and a predetermined amount of time has elapsed, the printer 103 stops operation in the network setup mode and deactivates the AP for setup. Also, in a case where connection information for connecting to an external AP and a change wireless communication operation mode instruction are received from the PC 101 while in the network setup mode, the AP for setup is deactivated.

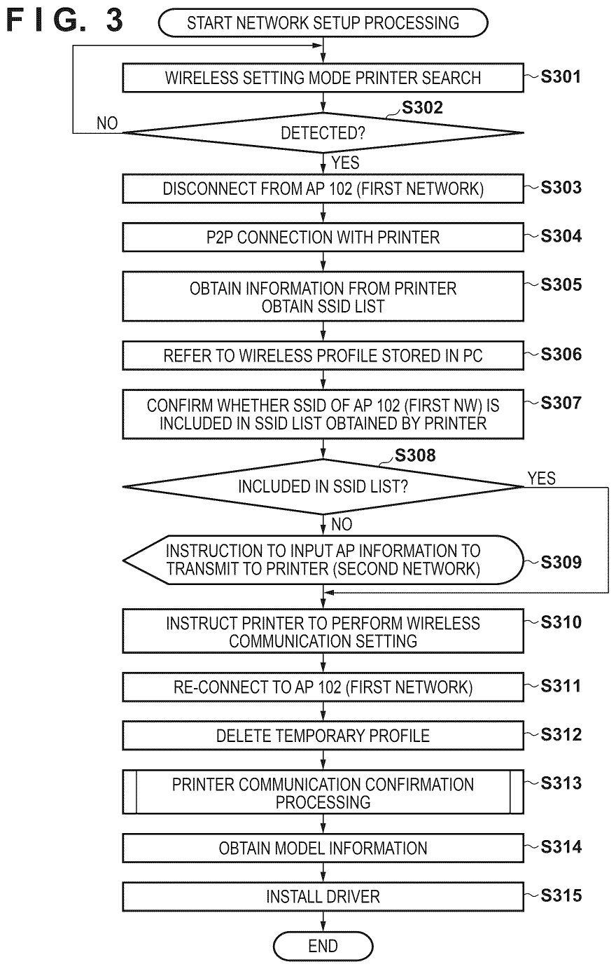

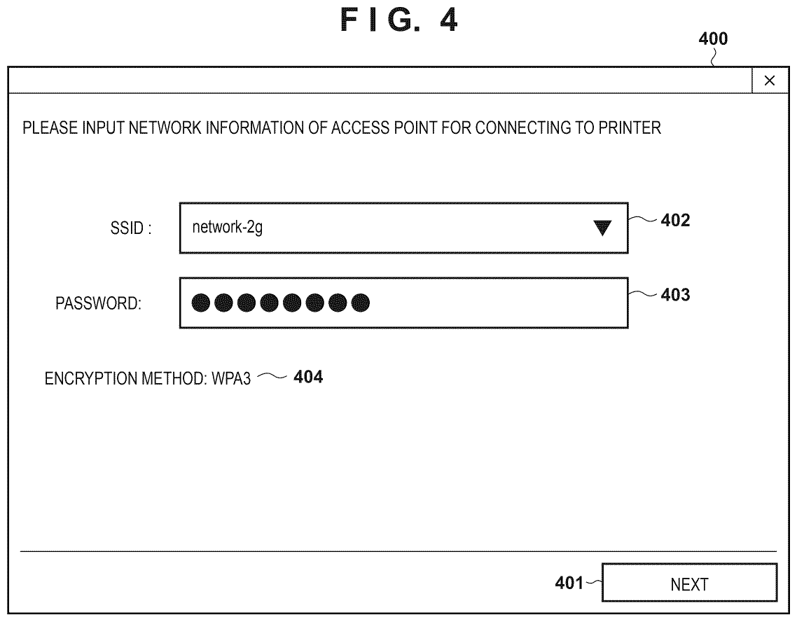

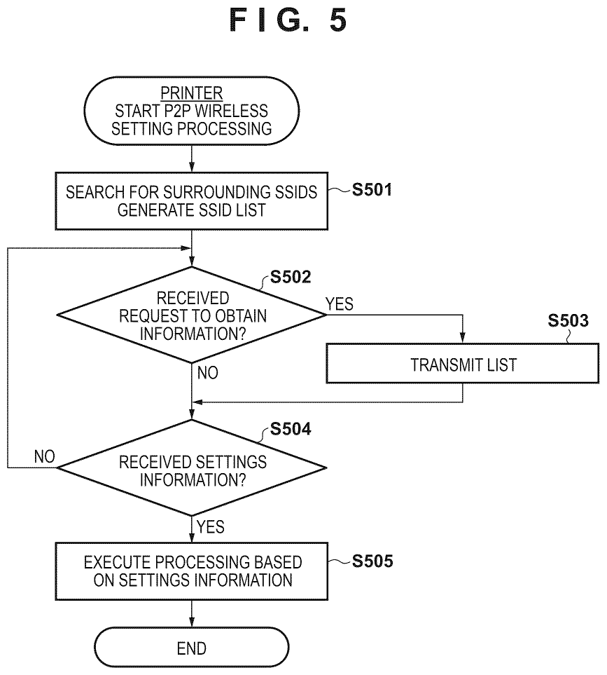

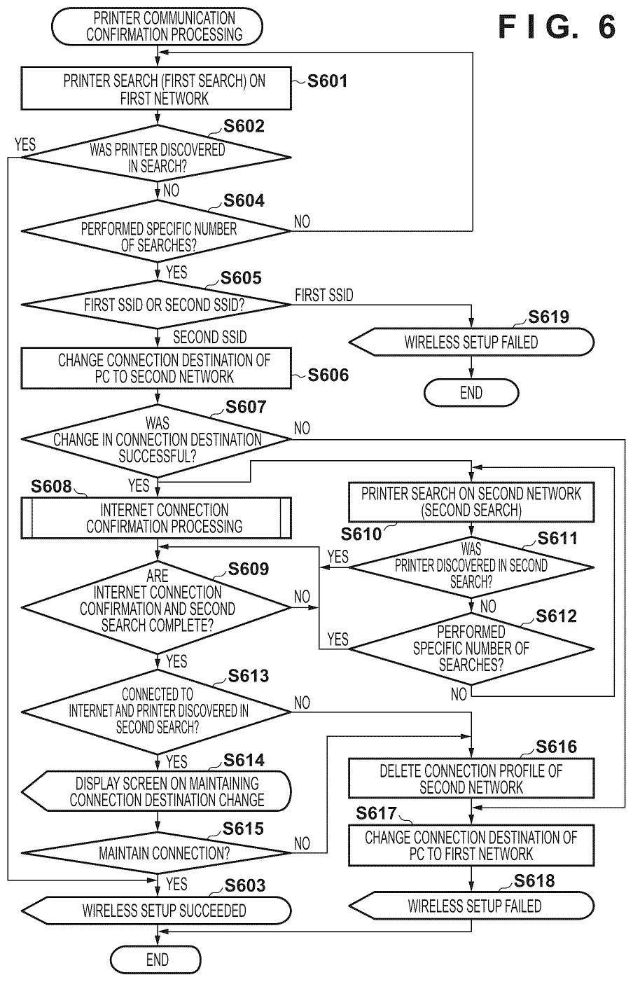

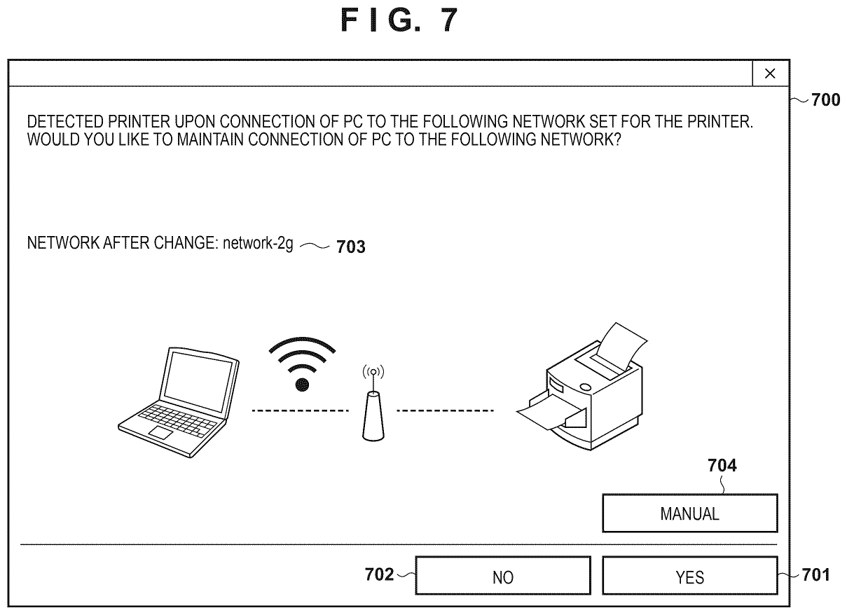

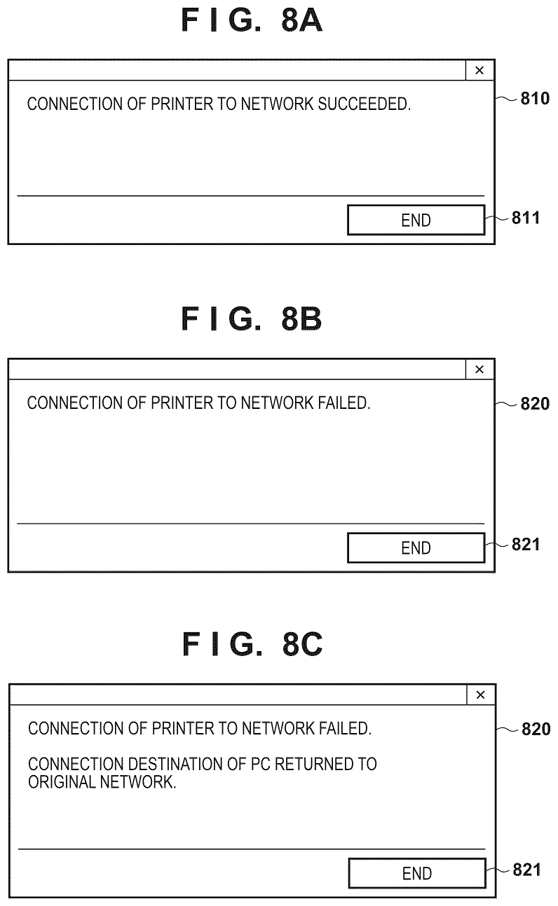

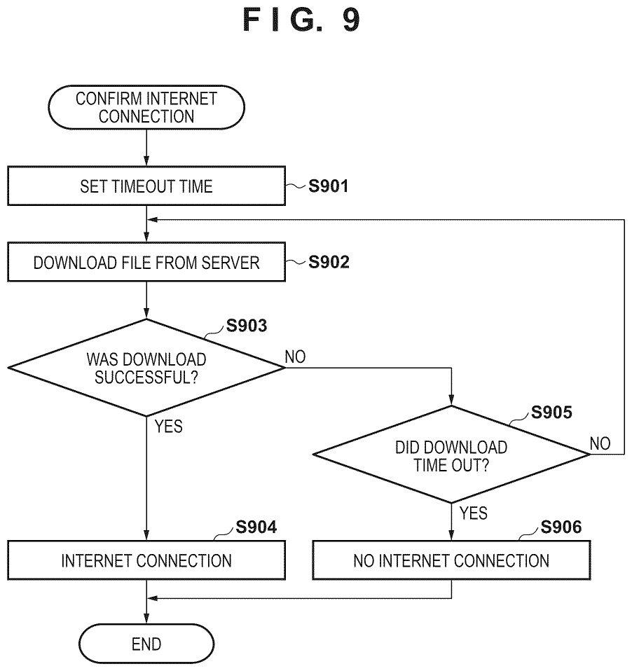

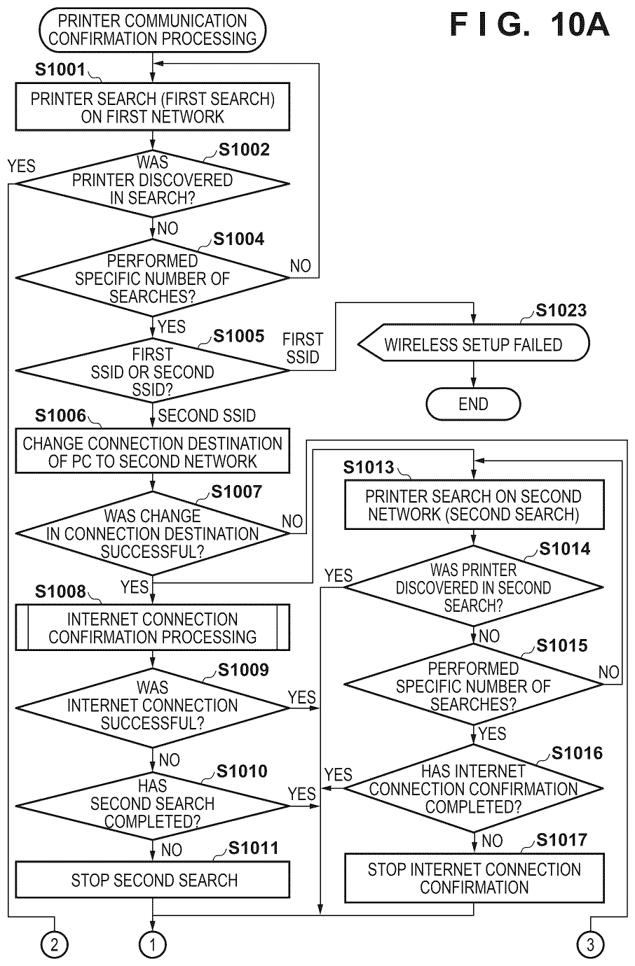

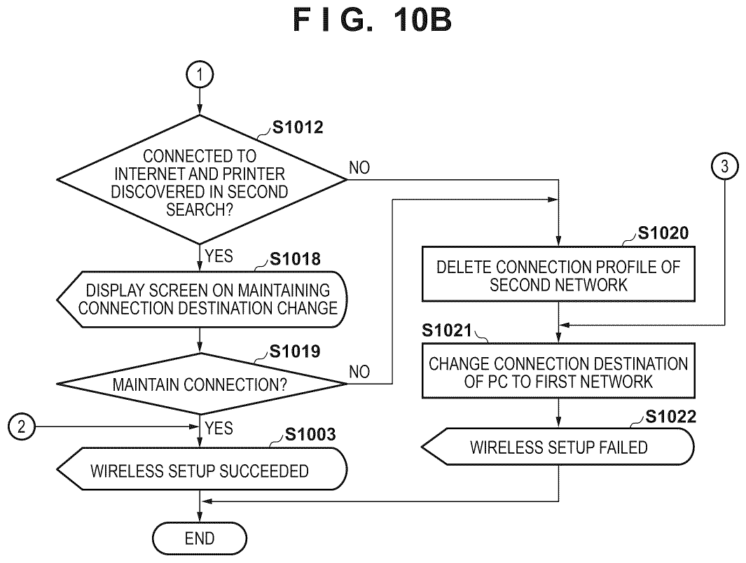

Operations according to the present embodiment will be described in detail below using FIGS. 3 to 9. FIG. 3 is a flowchart illustrating the processing (network setup processing) of the PC 101 to connect the printer 103 to the network of an external AP. FIG. 4 is a diagram illustrating an example of a screen displayed on the display apparatus 208 of the PC 101 in the network setup processing. FIG. 5 is a flowchart illustrating P2P wireless setting processing of the printer 103. FIG. 6 is a flowchart illustrating printer communication confirmation processing executed in step S313 of FIG. 3. FIGS. 7 and 8A to 8C are diagrams illustrating examples of screens displayed on the display apparatus 208 of the PC 101 in the printer communication confirmation processing of FIG. 6. FIG. 9 is a flowchart illustrating the Internet connection confirmation processing executed in step S608 of FIG. 6.

FIG. 3 is a flowchart illustrating the network setup processing of the printer 103 executed by the PC 101. The present flowchart is implemented by the CPU 201 reading out the program 203 stored in the ROM 202 onto the RAM 206 and executing the program 203. Note that in the present embodiment, the PC 101 executes processing via the application for setup. The present flowchart, for example, is started on the basis of the user performing a predetermined instruction on the screen displayed by the application for setup. Note that in a case where the PC 101 is connected to the AP 102 via the wired LAN interface 210, the SSID and password of the AP 102 are not stored in the wireless profile 204. In a case where the PC 101 is connected to the AP 102 via the wireless LAN interface 211, the SSID and password of the AP 102 are stored in the wireless profile 204.

When the user executes the program 203 and performs a predetermined operation in the program 203, the CPU 201 starts the network setup processing. Note that here, the PC 101 is already connected to the external AP 102, and the printer 103 is in the network setup mode. FIG. 1C illustrates the system configuration at this time. Also, the network formed by the AP 102 that the PC 101 is already connected to may be referred to below as a “first network”. Note that a connection with the AP in other words corresponds to a connection to the network formed by the AP. Similarly, the SSID, which is an identifier, of the first network may be referred to below as a “first SSID”. Specifically, for example, the first SSID is the SSID of the AP 102 that the PC 101 is already connected to. Also, the first network, to paraphrase, is a network that the PC 101 was connected to at least at the time when the predetermined operation was received by the PC 101.

In step S301, the CPU 201 searches for the printer 103 in the network setup mode. Specifically, for example, the CPU 201 searches for APs in the surroundings of the PC 101 and obtains the SSID of a discovered AP. Then, in step S302, the CPU 201 determines whether or not the discovered SSIDs includes a unique SSID known to the application for setup. A unique SSID is an SSID issued by the AP of the printer 103 in the network setup mode. Until it is determined that a unique SSID is included, the processing of steps S301 and S302 is repeated. In a case where it is determined that a unique SSID is included, the processing proceeds to step S303.

In step S303, the CPU 201 stores the settings information of the AP 102 that the wireless LAN interface 211 is connected to in the RAM 206. Then, the CPU 201 disconnects the wireless connection between the wireless LAN interface 211, and in step S304, the AP 102 and performs a P2P connection with the printer 103. Specifically, the CPU 201 connects the wireless LAN interface 211 to the AP with the unique SSID. Note that in a case where the PC 101 has a wired connection with the AP 102 via the wired LAN interface 210, in other words, when the PC 101 is not wirelessly connected to the AP 102, the processing of step S303 may be skipped. Also, in an example in which the PC 101 performs various types of communication with the printer 103 via communication systems other than Wi-Fi (Bluetooth, wired LAN, USB, or the like), the wireless connection between the wireless LAN interface 211 and the AP 102 may not be disconnected.

In step S305, the CPU 201 requests the printer 103 for an SSID list of APS in the surroundings of the printer 103 and receives an SSID list as a response to the request from the printer 103. Here, the received SSID list is a list of SSIDs of the surrounding APs detected (discovered) by the printer 103. In other words, the SSID list is a list of APs detected (discovered) by the printer 103. To further paraphrase, the SSID list is a list of networks detected (discovered) by the printer 103. Note that the request for the SSID list and the reception of the SSID list are communicated via the P2P connection, but may be communicated via a communication system other than Wi-Fi (Bluetooth, wired LAN, USB, or the like).

In step S306, the CPU 201 obtains the wireless profile 204 stored in the PC 101. Note that in a case where there are a plurality of networks that the PC 101 has previously connected to and a plurality of wireless profiles exist, the CPU 201 obtains the plurality of wireless profiles. Then, the CPU 201, from among the obtained wireless profiles, identifies and obtains the settings information (including the SSID) of the AP 102 connected to at the start of the network setup processing and with a wireless connection that was disconnected from in step S303.

In step S307, the CPU 201 confirms the SSID list obtained in step S305 on the basis of the SSID (the first SSID) of the AP 102 obtained in step S306. In step S308, on the basis of the confirmation result, the CPU 201 determines whether or not the first SSID of the AP 102 is included in the SSID list obtained in step S305. Determining whether or not the first SSID of the AP 102 is included in the SSID list obtained in step S305 corresponds to, in other words, determining whether or not information corresponding to the network formed by the AP 102 is included in the SSID list obtained in step S305.

In a case where the first SSID of the AP 102 is determined to be included in the SSID list obtained in step S305, the processing proceeds to step S310. The processing of step S310 will be described below. In a case where the first SSID of the AP 102 is determined to not be included in the SSID list obtained in step S305, in step S309, the CPU 201 displays the screen illustrated in FIG. 4 as an example for instructing the user to input the settings information (including the SSID and password) of the desired AP. The screen of FIG. 4 will be described below.

In step S308, if the SSID list being determined to not be included is because of the PC 101 being connected to the AP 102 via the wired LAN interface 210, this means that no wireless profiles exist. In such cases, in step S308, the first SSID of the AP 102 is determined to not be included in the SSID list obtained in step S305, and the processing proceeds to step S309.

Also, for example, take an example in which the PC 101 is connected to the AP 102 designating an SSID (the first SSID) for a 5 GHz frequency band and the printer 103 supports only wireless LAN communication at a 2.4 GHz frequency band. In other words, in such cases, the printer 103 does not support wireless LAN communication at a 5 GHz frequency band. A printer that does not support wireless LAN communication at a 5 GHz frequency band will be hereinafter referred to as a 5-GHz-noncompatible printer. In some cases, the wireless LAN router with the AP 102 enabled may enable a plurality of APs using different frequency bands. In such a case, in step S305, the 5-GHz-noncompatible printer detects only the SSIDs for the 2.4 GHz frequency band and transmits this as the SSID list to the PC 101. The PC 101 stores the wireless profiles relating to the SSIDs for the 5 GHz frequency band, but does not store the wireless profiles relating to SSIDs for the 2.4 GHz frequency band. Thus, in step S308, the first SSID of the AP 102 is determined to not be included in the SSID list obtained in step S305, and the processing proceeds to step S309.

When processing proceeds to step S309, the user needs to be made designate, on the PC 101, the AP settings information, such as the SSID and password, for the user-desired AP, that is, the AP the user wishes to connect the printer 103 to. In step S309, the CPU 201 displays a network information input screen 400 illustrated in FIG. 4 on the display apparatus 208. The network information input screen 400 includes a “Next” button 401, a drop-down list 402 for receiving selection of an “SSID name”, an input region 403 for inputting a “password”, and an encryption method display region 404 displaying the encryption method of the selected SSID. The drop-down list 402 lists the information of the SSID list obtained from the printer 103 in step S305. In other words, the network information input screen 400 may be referred to as a selection screen for displaying the SSID list obtained from the printer 103 and for receiving a user selection from the SSID list. When an SSID is selected from the drop-down list 402, the encryption method display region 404 displays the encryption method information of the SSID obtained from the printer 103 as attached information relating to the SSID. Note that among the wireless profiles obtained in step S306 by the CPU 201, there may be a wireless profile corresponding to an SSID selected from the drop-down list 402. In this case, by obtaining the password included in the wireless profile, the password may be automatically input into the input region 403. Also, in the present embodiment, the SSID is selected from the drop-down list 402, but no such limitation is intended. For example, instead of using the drop-down list 402, the user may be able to input any SSID name. Also, the encryption method display region 404 may be configured so that the user can select any encryption method.

The password input region 403 is a region for receiving input of a password character string for connecting to the selected SSID. A password is a key used in encryption using the encryption method displayed in the encryption method display region 404. In the password input region 403, for security reasons, the input password is display on the screen replaced with another character such as “●” to hide the password from others. However, the network information input screen 400 may be configured with a UI that can switch to display the input password characters as is for the user to confirm the input characters. In a case where an AP encryption method is not set, in other words, when it is an open authentication network, the password input region 403 may be set to a deactivated state requiring no input.

The network information input screen 400 is a screen that guides the user to input network information for connecting the printer 103 to the desired AP and to prompt the user to press the “Next” button 401. When the user presses the “Next” button 401 guided by the network information input screen 400, the CPU 201 temporarily stored the input network information (SSID, password, encryption method) in the RAM 206 as information corresponding to an AP wireless profile. At this time, the CPU 201 may execute processing to verify whether or not the input network information is correct. Specifically, for example, the CPU 201 may verify whether or not the input password matches a predetermined encryption method format. In a case where, for the verification result, it is determined that the password and encryption method are a combination resulting in an error, the CPU 201 again displays the network information input screen 400 and prompts the user to input correct information. A network that can be connected to using network information obtained via user input on the network information input screen 400 and that is formed by an AP corresponding to the network information is referred to below as a “second network”. Similarly, the SSID which is an identifier of the second network and the SSID of the AP formed by the second network is referred to as a “second SSID”. For example, the second network is a network formed by the AP 104, which is different from the AP 102 as illustrated in FIG. 1B. Also, the second network is a network different from the first network formed by the AP 102.

In step S310, the CPU 201 transmits a network setup instruction to the printer 103. In a case where, in step S308, it was determined that the first SSID of the AP 102 is included in the SSID list obtained in step S305, the network information of the first SSID is transmitted to the printer 103 as the network setup instruction. In other words, the settings information of the AP 102 that the PC 101 was connected to at the time of the start of the network setup processing is automatically selected without a user operation. Thus, user selection or input of the settings information (including the SSID and password) of the AP to connect the printer 103 to can be skipped. Also, in a case where, in step S309, the network information of the second network was obtained via user input, the network information of the AP of the second SSID is transmitted to the printer 103 as the network setup instruction. In other words, in step S310, either the settings information of the AP 102 identified by the first SSID or the settings information of the AP identified by the second SSID is transmitted to the printer 103. Note that the network setup instruction is transmitted via a P2P connection, but may be transmitted via a communication system other than Wi-Fi (Bluetooth, wired LAN, USB, or the like). Also, in an embodiment in which the network setup instruction is transmitted via a communication system other than Wi-Fi, the PC 101 may transmit the network setup instruction while connected to the first network via Wi-Fi.

In step S311, the CPU 201 disconnects the P2P connection with the printer 103 and re-connects to the AP 102 that was the connection destination of the PC 101 via the wireless connection disconnected in step S303. In a case where the wireless profile 204 of the AP 102 is stored in the ROM 202 inside the PC 101, in step S311, the CPU 201 obtains this and can re-connect to the AP 102 without requiring the user to input the password and the like again. Alternatively, in a case where the AP 102 is not set with an encryption method, the CPU 201 can re-connect to the AP 102 without requiring the password and the like to be input again via designation of the SSID of the AP 102. Note that in a case where the PC 101 is connected to the AP 102 via the wired LAN interface 210, the processing of step S311 is skipped.

In step S312, in a case where a wireless profile remains in the ROM 202 due to the temporary P2P connection, the CPU 201 deletes the wireless profile. If the wireless profile were to remain in the ROM 202, there is a possibility of the CPU 201 automatically connecting to the SSID storing the wireless profile remaining in the ROM 202 despite the intentions of the user. Thus, executing the processing of step S312 can prevent a wireless profile that may cause an unintentional connection from remaining. Note that the wireless profile may be unable to be deleted depending on the OS. In this case, step S312 is skipped.

In step S313, the CPU 201 determines whether or not communication between the printer 103 and the PC 101 is possible via the network that the PC 101 is connected to by executing printer communication confirmation processing. The printer communication confirmation processing of step S313 will be described below using FIG. 6.

In step S314, the CPU 201 obtains information relating to the model of the printer 103 from the printer 103 discovered in step S313 via the network that the PC 101 is connected to. Specifically, for example, information such as the printer serial number is obtained from the printer 103. Hereinafter, the information relating to the model of the printer 103 may be referred to as model information. In step S315, the CPU 201 executes processing for installing a printer driver corresponding to the printer 103 on the PC 101 on the basis of this information. Thereafter, the processing of FIG. 3 ends. Note that the CPU 201 may obtain the printer driver described above from an external server 171 via the Internet. Also, a printer driver may be included in with the application for setup. Also, in a case where the printer 103 is not discovered in step S313, the processing of steps S314 and S315 may be skipped.

Next, the P2P wireless setting processing of the printer 103 will be described in detail with reference to FIG. 5. The present flowchart is implemented by the CPU 252 reading out the program 254 stored in the ROM 253 onto the RAM 258 and executing the program 254.

The CPU 252 starts the processing of FIG. 5 on the basis of the occurrence of an event corresponding to a trigger for transitioning into the network setup mode. This event, for example, may be the user operating the input interface 260 of the printer 103 to turn on the power to the printer 103. Note that at this time, in a case where the printer 103 is powered on for the first time since shipping, the operation of turning on the power to the printer 103 may be considered an event corresponding to a trigger for transitioning into the network setup mode. Also, the event, for example, may be the user operating the input interface 260 of the printer 103 to transition into the network setup mode that is different from the operation of turning on the power.

Note that in the printer 103 in the network setup mode, the wireless LAN interface 256 operates as an AP with a unique SSID as described above. For example, a unique SSID includes a character string corresponding to the model name of the printer 103, “printer”, or a similar character string from which the printer 103 can be deduced from the SSID. The network setup mode is a mode that allows the PC 101 to easily connect to the printer 103 without using authentication information (a password and the like). The printer 103 in the network setup mode operates as an AP with a reduced security level. Thus, the network setup mode is only temporarily used when performing the network setup of the printer 103.

In step S501, the CPU 252, before transitioning the printer 103 into the network setup mode, searches for APs in the surroundings of the printer 103 and generates an SSID list including the SSIDs of discovered APs. Note that here, discovered APs are APs that the printer 103 can connect to. In other words, an AP that the printer 103 cannot connect to is not found by the search performed here. An AP that the printer 103 cannot connect to is, for example, an AP using a frequency band that the printer 103 cannot use or an AP using an encryption method that the printer 103 cannot use. Note that the AP search is, in other words, a search for a network formed by an AP. Thus, as described above, the SSID list generated here is, in other words, a list of networks discovered by the search performed by the printer 103. In step S502, the CPU 252 transitions the printer 103 into the network setup mode and determines whether or not a request to obtain the SSID list has been received from the PC 101. This processing corresponds to step S305 of FIG. 3. In a case where, in step S502, it is determined that a request to obtain the SSID list has been received from the PC 101, in step S503, the CPU 252 executes processing to transmit the SSID list requested by the PC 101. Specifically, the CPU 252 transmits the SSID list generated in step S501 to the PC 101. In step S502, in a case where it is determined that a request to obtain the SSID list from the PC 101 has not been received, the processing proceeds to step S504.

In step S504, the CPU 252 determines whether or not a network setup instruction has been received from the PC 101. This processing corresponds to step S310 of FIG. 3. Note that the network setup instruction including AP settings information. In a case where, in step S504, it is determined that a network setup instruction has not been received, the processing is repeated from step S502. In a case where, in step S504, it is determined that a network setup instruction has been received, in step S505, the CPU 252 executes connection processing for the AP corresponding to the received AP settings information. Specifically, for example, if the wireless profile 204 is included in the AP settings information received from the PC 101, the CPU 252 uses the SSID and password included in the wireless profile 204 to execute connection processing for the AP 102. Also, for example, if the network information of the second network input in the PC 101 in step S309 is included in the AP settings information received from the PC 101, the CPU 252 uses the network information to execute connection processing for the external AP forming the second network. After step S505, the P2P wireless setting processing of FIG. 5 ends. The determination for receiving a network setup instruction may be performed before the determination for receiving a request to obtain the SSID list.

The printer communication confirmation processing of step S313 of FIG. 3 will now be described using FIG. 6.

In step S601, the CPU 201 searches for the printer 103 on the first network formed by the AP 102, which is the network that the PC 101 belongs to. Specifically, for example, a broadcast packet or a multicast packet is transmitted to search for the printer 103. For example, in a case where the printer 103 and the PC 101 are connected to the same AP 102 and the security function (SSID separation function) of the AP 102 is not activated, a response to a packet transmitted in the search is received from the printer 103 via the first network. In other words, the printer 103 is discovered by the present search. Hereinafter, the processing for searching for the printer 103 on the first network is referred to as a first search.

In step S602, the CPU 201 determines whether or not the printer 103 has been discovered via the first search of step S601. In a case where it is determined that the printer 103 has been discovered, in step S603, the CPU 201 displays a screen indicating that the printer 103 has been discovered via the first search of step S601 on the display apparatus 208. Here, for example, a screen 810 illustrated in FIG. 8A is displayed on the display apparatus 208. The screen 810 includes a message indicating that the printer 103 has been discovered and a message indicating the connection with the printer 103 has been successful. Also, the screen 810 includes an end button 811 for ending the processing. In a case where the end button 811 is pressed, the printer communication confirmation processing of FIG. 6 ends.

In a case where it is determined that the printer 103 has not been discovered via the first search of step S601, in step S604, the CPU 201 determines whether or not the first search of step S601 has been performed a specific number of times. In a case where the first search of step S601 has not been performed the specific number of times, the processing from step S601 is repeated. In a case where the first search of step S601 has been performed the specific number of times, the processing proceeds to step S605.

In step S605, the CPU 201 determines whether, in step S310, the AP network information of the first SSID was transmitted or the AP network information of the second SSID was transmitted. In a case where it is determined that, in step S310, the AP network information of the first SSID was transmitted, the processing proceeds to step S619, and the CPU 201 displays a screen illustrated in FIG. 8B indicating that network connection with the printer 103 has failed on the display apparatus 208. For example, a screen 820 displays a message indicating that the printer 103 could not be discovered or a message indicating that connection with the printer 103 failed. Also, the screen 820 may include a message indicating that a change of the connection destination of the wireless LAN interface 211 has failed. The screen 820 includes an end button 821 for ending the processing. In a case where the end button 821 is pressed, the processing of FIG. 6 ends. In a case where it is determined that, in step S310, the AP network information of the second SSID has been transmitted, the processing proceeds to step S606.

In step S606, the CPU 201 disconnects the connection between the wireless LAN interface 211 and the first SSID network and attempts to establish a connection between the wireless LAN interface 211 and the second SSID network. In other words, the CPU 201 attempts to change the connection destination of the wireless LAN interface 211. Note that the attempt to establish a connection between the wireless LAN interface 211 and the second SSID network is performed while the application for setup is running and via an instruction from the application for setup. Then, in step S607, the CPU 201 determines which the change of the connection destination of the wireless LAN interface 211 was successful or not. Note that the change of the connection destination of the wireless LAN interface 211 being successful corresponds to, in other words, the establishment of a connection between the wireless LAN interface 211 and the second SSID network being successful. Also, in a case where the wireless LAN interface 211 automatically obtains the IP address, the CPU 201 may consider this as the change of the connection destination being successful due to the IP address after the connection with the AP 102 being allocated.

In a case where the change of the connection destination of the wireless LAN interface 211 failed, in step S617, the CPU 201 re-connects the wireless LAN interface 211 to the first SSID network. Then, in step S618, the CPU 201 displays a screen indicating the failure of the network connection of the printer 103 on the display apparatus 208. Note that, in the present embodiment, on the basis of the printer 103 being discovered on the network by the PC 101 as a result of the network setup processing, the network connection of the printer 103 is successful. Here, for example, the screen 820 illustrated in FIG. 8C is displayed on the display apparatus 208. For example, the screen 820 displays a message indicating that the printer 103 could not be discovered or a message indicating that connection with the printer 103 failed. Also, on the screen 820, a message indicating that the connection destination of the wireless LAN interface 211 has been re-connected to the first SSID network is displayed. Also, the screen 820 may include a message indicating that a change of the connection destination of the wireless LAN interface 211 has failed. The screen 820 includes the end button 821 for ending the processing. In a case where the end button 821 is pressed, the processing of FIG. 6 ends.

On the basis of it being determined, in step S607, that the change of the connection destination of the wireless LAN interface 211 was successful, the CPU 201 starts both the processing of step S608 and the processing of step S610. In other words, in a case where, in step S607, it is determined that the change of the connection destination of the wireless LAN interface 211 was successful, the CPU 201 executes the processing of step S608 and the processing of step S610 in parallel. Note that the timing of when the processing of step S608 is started and the timing of when the processing of step S610 is started do not have to be strictly at the same time. Specifically, for example, the CPU 201 may start the processing of the processing of step S610 after the start of the processing of step S608 but before completion of the processing of step S608, and may start the processing of step S608 after the start of the processing of step S610 but before the completion of the processing of step S610. Also, the timing of when the processing of step S608 is completed and the timing of when the processing of steps S610 to S612 is completed may be at the same time or different. In other words, in a case where, in step S607, it is determined that the change of the connection destination of the wireless LAN interface 211 was successful, the CPU 201 may perform control so that at least a part of the processing of step S608 and at least a part of the processing of steps S610 to S612 are executed in parallel.

In step S608, the CPU 201 confirms whether the PC 101 is in state of being connected to the Internet. In other words, the CPU 201 confirms whether the PC 101 can access the external server 171 via the Internet. Note that the PC 101 being in a state of being connected to the Internet corresponds to, in other words, a state in which the PC 101 can communicate via the Internet. Also, in the present embodiment, in step S608, the CPU 201 confirms whether or not Internet communication via the second network can be performed. Thus, the processing of step S608 is, in other words, confirming whether the PC 101 is in a state of being connected to the Internet via the second network. The processing of step S608 to confirm whether the PC 101 is in a state of being connected to the Internet will be described below using FIG. 9. When confirmation of whether the PC 101 is connected to the Internet is complete, The CPU 201 proceeds the processing to step S609.

In parallel with step S608, in step S610, the CPU 201 searches for the printer 103 on the second network. Specifically, for example, a broadcast packet or a multicast packet is transmitted to search for the printer 103. In a case where the printer 103 and the PC 101 are connected to the same second network and thus the security function (SSID separation function) of the AP 102 is activated, a response to a packet transmitted in the search is received from the printer 103 via the second network. In other words, the printer 103 is discovered by the present search. Hereinafter, the processing for searching for the printer 103 on the second network is referred to as a second search.

In step S611, the CPU 201 determines whether or not the printer 103 has been discovered via the second search of step S610. In a case where it is determined that the printer 103 has not been discovered via the second search of step S610, in step S612, the CPU 201 determines whether or not the second search of step S610 has been performed a specific number of times. In a case where the second search of step S610 has not been performed the specific number of times, the processing from step S610 is repeated. In a case where the second search of step S610 has been performed the specific number of times, the processing proceeds to step S609.

In step S609, the CPU 201 determines whether the Internet connection confirmation processing of step S608 and the second-search-related processing are complete. The second-search-related processing corresponds to steps S611 and S612, and in a case where the determination result of step S611 is yes or the determination result of step S612 is yes, the second-search-related processing is considered to be complete. In a case where it is determined that either the Internet connection confirmation processing or the second-search-related processing is not complete, the CPU 201 repeats the processing of step S609 until the processing is complete.

On the other hand, in a case where the CPU 201 determines that the Internet connection confirmation processing and the second-search-related processing are complete, the processing proceeds to step S613. In step S613, the CPU 201 determines whether the PC 101 is connected to the Internet and whether the printer 103 has been discovered in the second search of step S610. In a case where the determination result of step S903 is yes and the determination result of step S611 is yes, the CPU 201 determines yes for step S613. In a case where the determination result of step S903 is no or the determination result of step S612 is yes, the CPU 201 determines no for step S613. This determination can reduce failures in the processing to obtain the printer driver from the external server 171 in step S315 on the basis of the model information of the printer 103 obtained in step S314 after the end of the processing of FIG. 6.

In a case where it is determined that the PC 101 cannot connect to the Internet or the printer 103 cannot be discovered (a determination result in step S613 of no), in step S616, the CPU 201 deletes the wireless profile of the second network stored in the PC 101. Thus, as described above, the processing of step S616 can prevent a wireless profile that may cause an unintentional connection from remaining. Note that the wireless profile may be unable to be deleted depending on the OS. In this case, step S616 is skipped.

In step S617, the CPU 201 disconnects the connection between the wireless LAN interface 211 and the second network and re-connects the wireless LAN interface 211 to the first network. Note that the establishment of a connection between the wireless LAN interface 211 and the first network is performed while the application for setup is running and via an instruction from the application for setup. Also, directly after the connection between the wireless LAN interface 211 and the second network is disconnected, since there is a possibility that the OS is in an unstable state having been unable to search for a surrounding SSID. Thus, there is a possibility of re-connection failing. Thus, after a certain amount of time has passed since the disconnection of the connection to the second network, the CPU 201 may attempt to re-connect to the first network. Alternatively, in a case where re-connection to the first network fails, attempting to re-connect to the first network may reduce the number of connection failures. Then, in step S618, the screen 820 indicating the failure of the network connection of the printer 103 of FIG. 8C is displayed on the display apparatus 208. In a case where the end button 821 of the screen 820 illustrated in FIG. 8C is pressed, the CPU 201 ends the processing of FIG. 6.

Next, processing in a case where, in step S613, the PC 101 is connected to the Internet and it is determined that the printer 103 has been discovered via the second search (a case where the determination result of step S613 is yes) will be described. In step S614, the CPU 201 displays, on the display apparatus 208, a confirmation screen for the user to confirm whether or not to maintain the connection between the changed connection destination network (the second network) and the PC 101. Here, for example, a confirmation screen 700 illustrated in FIG. 7 is displayed on the display apparatus 208. For example, the confirmation screen 700 includes a region 703 displaying a message indicating that the printer 103 has been discovered on the second network or a message indicating that the wireless LAN interface 211 has connected to the second SSID network and the second SSID. Also, for example, the confirmation screen 700 includes a “Manual” button 704 for displaying a manual showing a detailed description and a “Yes” button 701 and a “No” button 702 operated by the user in response to the content of the message.

When the connection between the PC 101 and the second network is maintained, there is a possibility that the PC 101 is unable to execute communication with other external devices connected to the first network. Regarding this, when the “Manual” button 704 included in the confirmation screen 700 is pressed, a description of cautionary notes relating to maintaining the changed connection destination network of the PC 101 is displayed as a web manual, which is Internet content, via a web browser or the like. Specifically, for example, the content includes a description of how the communication with the external device connected to the first network may be cutoff if the connection destination of the PC 101 is changed to the second network and maintained there. Note that in this example, the display occurs when the “Manual” button 704 is pressed, but no such limitation is intended. For example, the content may be embedded in the display on the confirmation screen 700. Alternatively, a message corresponding to the content matter may be displayed on the confirmation screen 700. The confirmation screen 700 is a screen that displays a message for the user to confirm whether or not to maintain the state of the PC 101 being connected to the second network and that prompts the user to press either the “Yes” button 701 or the “No” button 702. In other words, the confirmation screen 700 may be referred to as a selection screen that can receive a user instruction of whether to set the connection destination of the PC 101 to the first network or the second network. Also, in other words, the confirmation screen 700 is a screen for the user to confirm whether or not to switch the connection destination of the PC 101 to the connection destination network before the change (the first network). In other words, the confirmation screen 700 is a reception screen for receiving a user instruction of whether or not to maintain the change of the network that the PC 101 belongs to from the first network to the second network.

In step S615, the CPU 201 determines whether or not to maintain the connection to the second network. Specifically, for example, when the user presses the “Yes” button 701, the CPU 201 determines to maintain the connection to the second network of the wireless LAN interface 211 and, in step S603, display the screen 810 illustrated in FIG. 8A on the display apparatus 208. In a case where the end button 811 included on the screen 810 is pressed, the processing of FIG. 6 ends. In this case, even in a case where an operation to end the processing of FIG. 6 has been received, the connection to the second network of the wireless LAN interface 211 is maintained. In other words, even if an operation to end the processing of FIG. 6, a switch from the second network of the wireless LAN interface 211 to the first network is not performed. On the other hand, when the user presses the “No” button 702, the CPU 201 determines to not maintain the connection to the second network of the wireless LAN interface 211, and the processing proceeds to step S616. The processing of step S616 from here onward is the same as described above.

In the processing of FIG. 6, the determination processing of steps S604 and S612 may be executed using a condition of whether or not the amount of processing time for executing the first search of step S601 and the second search of step S610 reached a specific amount of time (for example, a predetermined number of seconds) instead of using a condition of whether or not the number of execution times of the first search of step S601 and the second search of step S610 has reached a specific number of times. In this case, until a certain amount of time has passed, the first search of step S601 and the second search of step S610 in steps S601 and S610 are repeated. Also, the condition in steps S604 and S612 may not be the same. In other words, in one search, the determination may be performed on the basis of a condition of whether or not a specific number of times has been reached, and in the other search, the determination may be performed on the basis of whether or not a specific number of seconds has been reached.

Also, when the first search of step S601 is performed, there is a possibility that the printer 103 is executing processing to connect to the AP on the basis of AP settings information transmitted from the PC 101. Thus, determining a threshold for the first search of step S601 needs to be performed taking into account the amount of time taken by the processing being executed by the printer 103. However, in the second search of step S610, the search is performed after a sufficient amount of time has passed. Thus, there is a high possibility that the printer 103 has already completed connection to the second network, and there is not need to determine a threshold taking into account the amount of time taken for the printer 103 to connect to the AP 102. Therefore, the threshold relating to the second search of step S610 is set to a number of times less than the threshold relating to the first search of step S601 or to a shorter amount of time than the threshold relating to the first search of step S601. Accordingly, the amount of processing time of FIG. 6 can be kept to a minimum.

Processing to confirm whether or not the PC 101 is connected to the Internet in step S608 will now be described using FIG. 9.

In step S901, the CPU 201 sets the timeout time for when downloading a specific file. Specifically, the CPU 201 uses an API of the OS to attempt to download a specific file from the external server 171 in the processing of step S902 described below. For the API, the CPU 201 sets the timeout time for when download of the specific file shows no progress when downloading is being executed. The timeout time can be set to any amount of time and may be set to the amount of time taken by the second search of step S610 of FIG. 6, for example. In this manner, in a case where the download processing of step S910 fails and the second search of step S610 fails, the CPU 201 can send a notification of the download failure at approximately the same time as when the second search of step S610 fails and timeout occurs, allowing downloading to be executed in the optimal amount of time. Also, in a case where the amount of time taken by the second search of step S610 is the same as a default value of the timeout time of the API for attempting download in step S902, step S901 may be skipped.

Also, the specific file may be any file and may be the same file as the file of the model information obtained in step S314 of FIG. 3. Using the file that is the same as the obtained file at a timing different from in step S314 or the like in the Internet connection confirmation processing removes the need for the external server 171 to prepare a new file for the Internet connection confirmation processing. Also, as described above, in step S314 of FIG. 3, the CPU 201 obtains the model information of the printer 103. However, in a case where the download of the specific file (the file of the model information of the printer 103) is successful in step S902, the processing of step S314 may be skipped. In other words, in a case where the CPU 201 confirms that the second network is connected to the Internet in step S313 (successful download), the processing of step S314 may be skipped. In other words, in a case where download of the specific file is successful in the Internet connection confirmation processing, the same file does not need to be obtained again by the CPU 201 at a different timing to the confirmation processing. In a case where, in step S313, it is confirmed that the second network is connected to the Internet, the processing of step S314 may be skipped to allow the network setup processing to be progressed through in a time-efficient manner. Note that the specific file may be a file that is different from the file of the model information of the printer 103. For example, though it becomes necessary to prepare a new file in the external server 171, the specific file may be a file that is used only in the Internet connection confirmation processing.

In step S902, the CPU 201 executes downloading of the specific file from the external server 171 via the second network. Specifically, the CPU 201 attempts to download the specific file from the external server 171 by executing the API of the OS described in step S901. In other words, the CPU 201 does not used the OS-standard API described above and executes an API different from the OS-standard API. Accordingly, even in a case where an OS-standard API for determining whether or not the PC 101 is connected to the Internet is not provided, such as with macOS, for example, the OS of the PC 101 can determine whether or not the PC 101 is connected to the Internet.

In step S903, the CPU 201 determines whether or not download of the specific file has been successful in step S902. In a case where it is determined that download of the specific file has been successful, this can be considered as a state in which the PC 101 is connected to the Internet. In this case, in step S904, the CPU 201 determines that the PC 101 can access the external server 171 (can connect to the Internet) and ends the processing of FIG. 9. In a case where it is determined that download of the specific file has not been successful, in step S905, the CPU 201 determines whether or not the timeout time for downloading has elapsed. In a case where it is determined that the timeout time for downloading has not elapsed, the CPU 201 returns to the processing of step S902. In a case where it is determined that the timeout time for downloading has elapsed, this can be considered as a state in which the PC 101 cannot connect to the Internet. In this case, in step S906, the CPU 201 determines that the PC 101 cannot access the external server 171 (cannot connect to the Internet) and ends the processing of FIG. 9.

Note that, for example, the PC 101 connection to the second network via the wireless LAN and the PC 101 connection to another network other than the second network via wired LAN or the like may be performed in parallel and established. In such a case, in step S902, the CPU 201 may further attempt to download the specific file via the other network described above. In other words, the processing executed in step S902 may be processing for confirming whether or not the PC 101 is connected to the Internet via any network instead of being processing for confirming whether or not the PC 101 is connected to the Internet via one specific network that is the second network. Also, in a case where download of the specific file via the other network is successful, YES may be determined in step S903. In other words, specifically, for example, since the second network is not connected to the Internet, even if download of the specific file via the second network fails, YES may be determined in step S903 if download of the specific file via another network is successful. Note that downloading of the specific file via the other network may also be executed with the trigger being the same API as the API for downloading the specific file via the second network. Note that in a case where the connection with the external network established by the PC 101 is only a connection with the second network via the wireless LAN, in step S902, processing is executed for confirming whether or not there is an Internet connection via the second network.

Note that in the present example, a mode is described in which, in the Internet connection confirmation processing of step S608, an OS API is used to attempt to download the specific file from the external server 171 via the second network. However, no such limitation is intended.

In step S608, for example, an API may be used to attempt to upload the specific file to the external server 171 via the second network, and whether or not there is an Internet connection may be confirmed on the basis of the upload attempt result. For example, in a case where upload of the specific file is successful, the CPU 201 may confirm that the PC 101 is connected to the Internet via the second network. Also, for example, in a case where upload of the specific file fails, the CPU 201 may confirm that the PC 101 cannot connect to the Internet via the second network. In other words, in step S608, the CPU 201 attempts to communicate with the external server 171 via the second network and confirms whether or not there is an Internet connection on the basis of the communication result. Note that in a case where uploading is attempted in step S608, the specific file may be a file for Internet connection confirmation, for example.

Also, in a case where, in step S608, the OS of the PC 101 provides an OS-standard API that obtains the Internet connection status of the PC 101, for example, the OS-standard API may be used to confirm whether or not there is an Internet connection.

As described above, in the present embodiment, the CPU 201 connects the PC 101 to the second network and determines whether communication with the printer 103 can be performed. Also, in a case where it is determined that communication between the PC 101 and the printer 103 can be performed, the CPU 201 confirms with the user whether or not to change to the second network. In this manner, only in a case where the user allows a change to the second network does the CPU 201 change the connection destination of the PC 101 from the first network to the second network. Thus, as a result of the connection destination network of the PC 101 being automatically switched to the second network, the communication between the PC 101 and the communication device that was connected to the first network becoming unable to be performed and having to switch back to the original network can be prevented. This can improve the user-friendliness. Here, the PC 101 can establish a state in which it can communicate with the printer 103 on the second network and can end the network setup processing. Accordingly, for example, after the network setup processing ends, if the user executes processing such as issuing a printing instruction to the printer 103, the printing processing can be successfully executed without causing an error. Also, in a case where the connection destination of the PC 101 is to be changed from the first network to the second network, it is indicated to the user that connection with the communication device on the first network may be disconnected. This can prevent the user from performing the change without recognizing the possibility of disconnection. Also, after the connection destination of the PC 101 is changed from the first network to the second network, Internet connection confirmation processing and the second search of step S610 are performed in parallel. This allows the processing to proceed in a time-efficient manner. Via such a mode, the user-friendliness can be further improved.

### Second Embodiment

The differences between the second embodiment and the first embodiment will be described below. In the present embodiment, in a case where the printer 103 is not discovered in the second search of step S1013 (step S1013 will be described below), the status of the Internet connection confirmation processing being executed in parallel is confirmed. In a case where the Internet connection confirmation processing is not complete, the Internet connection confirmation processing is stopped, and the connection destination of the PC 101 is returned to the first network. Then, a wireless setup failure notification is displayed on the display apparatus 208. Also, in a similar manner, in a case where the Internet connection confirmation processing is complete, whether the second search of step S1013 is complete is confirmed. In a case where the second search of step S1013 is not complete, the second search of step S1013 is stopped, and the connection destination of the PC 101 is returned to the first network. Then, a wireless setup failure notification is displayed on the display apparatus 208. In this manner, in a case where either one of the processing of the Internet connection confirmation processing or the second search of step S1013 fails, this can be recognized as wireless setup failing, and the processing can proceed in a time-efficient manner.

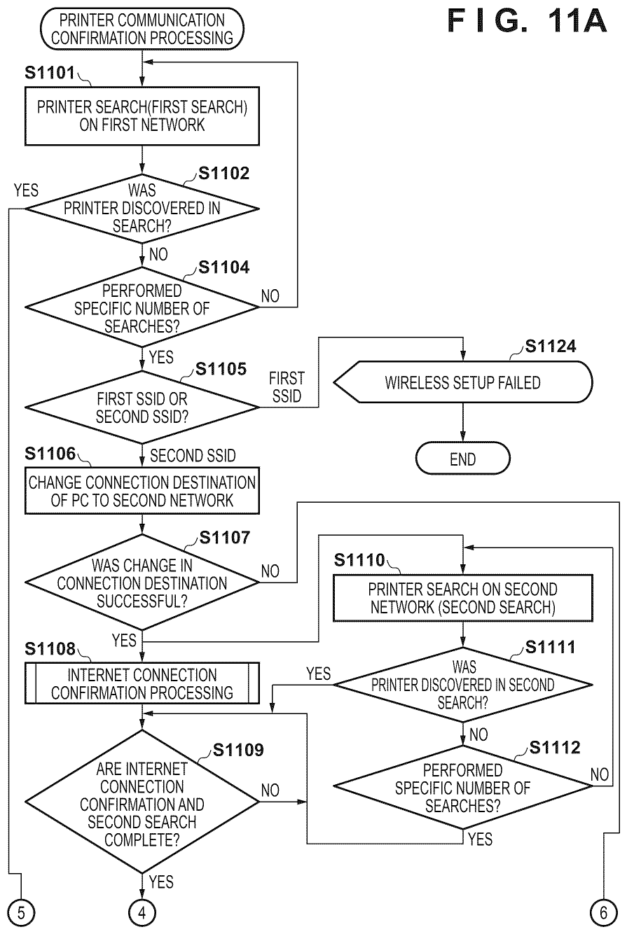

The printer communication confirmation processing of step S314 according to the present embodiment will now be described using FIGS. 10A and 10B. The processing of FIGS. 10A and 10B are implemented by the CPU 201 reading out the program 203 stored in the ROM 202 onto the RAM 206 and executing the program 203, for example. Note that the processing of FIGS. 10A and 10B are implemented via the application for setup. Also, the processing of FIGS. 10A and 10B, for example, is started on the basis of the user performing a predetermined instruction on a screen displayed by the application for setup.

Steps S1001 to S1008, steps S1013 to S1015, and step S1023 are the same as described for steps S601 to S608, steps S610 to S612, and step S619 of FIG. 6 and thus description thereof will be omitted.

In step S1009, the CPU 201 determines whether or not the PC 101 is connected to the Internet as a result of step S1008. In a case where it is determined that there is an Internet connection, the CPU 201 proceeds to step S1012. In a case where it is determined that the PC 101 cannot connect to the Internet, in step S1010, the CPU 201 determines whether or not the second search of step S1013 is complete. In a case where it is determined that the second search of step S1013 is complete, the CPU 201 proceeds to step S1012. In a case where it is determined that the second search of step S1013 is not complete, in step S1011, the CPU 201 stops the execution of the second search of step S1013. In other words, in the present embodiment, in a case where it is confirmed that the PC 101 cannot connect to the Internet during the second search, the second search is stopped.

On the other hand, in step S1015, the CPU 201 determines whether or not the second search of step S1013 being executed in parallel has been performed a specific number of times. In a case where the CPU 201 determines that the second search has not been performed the specific number of times, the processing returns to step S1013. In a case where the CPU 201 determines that the second search has been performed the specific number of times, in step S1016, the CPU 201 determines whether or not the Internet connection confirmation is complete. In a case where it is determined that the Internet connection confirmation is complete, the CPU 201 proceeds to step S1012. In a case where it is determined that the Internet connection processing is not complete, in step S1017, the CPU 201 stops the Internet connection confirmation processing of step S1008. In other words, in the present embodiment, in a case where the printer 103 is not discovered by the second search during the Internet connection confirmation, the Internet connection confirmation processing is stopped.

Step S1012 and steps S1018 to S1022 are the same as described for step S613 and steps S614 to S618 of FIG. 6 and thus description thereof will be omitted.

As described above, according to the present embodiment, in step S1011, in a case where it is determined that the PC 101 cannot connect to the Internet due to the second search of step S1013 being stopped, it can be immediately determined that wireless setup has failed. Also, in a similar manner, in step S1017, in a case where the printer 103 cannot be discovered in the second search of step S1013 due to the Internet connection confirmation being stopped, it can be immediately determined that wireless setup has failed. With this mode, the processing can be executed in a time-efficient manner.

### Third Embodiment

The differences between the third embodiment and the first and second embodiment will be described below. In the present embodiment, in a case where the PC 101 cannot connect to the Internet or the printer 103 is not discovered by the second search of step S1110 (step S1110 will be described below), the CPU 201 changes the connection destination of the PC 101 to the first network. Thereafter, the CPU 201 determines whether or not the printer 103 has been discovered via the second search of step S1110. In a case where the printer 103 is discovered via the second search of step S1110, the CPU 201 changes the connection destination of the PC 101 to the first network. Also, the CPU 201 displays, on the display apparatus 208, that the printer 103 successfully connected to the designated SSID but the connected SSID was not connected to the Internet, thus wireless setup failed. Accordingly, the user can know that the printer 103 was successfully connected to the SSID, but that printer communication confirmation processing failed because of no Internet connection. In other words, in a case where the user performs wireless setup again, the user can recognize that if they connect to an SSID with an Internet connection, wireless setup will be successful.

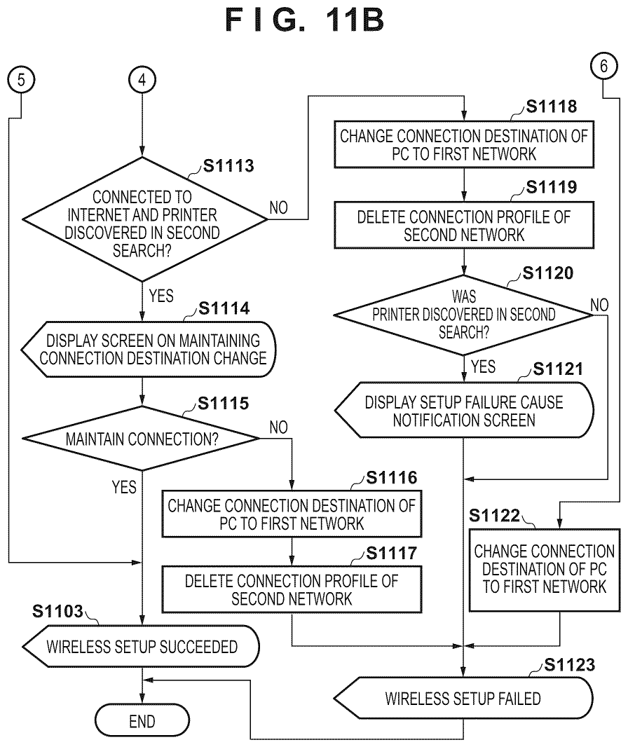

The printer communication confirmation processing of step S314 according to the present embodiment will now be described using FIGS. 11A and 11B. The processing of FIGS. 11A and 11B are implemented by the CPU 201 reading out the program 203 stored in the ROM 202 onto the RAM 206 and executing the program 203, for example. Note that the processing of FIGS. 11A and 11B are implemented via the application for setup. Also, the processing of FIGS. 11A and 11B, for example, are started on the basis of the user performing a predetermined instruction on a screen displayed by the application for setup.

Steps S1101 to S1112 and step S1124 are the same as described for steps S601 to S612 and step S619 of FIG. 6 and thus description thereof will be omitted.

In step S1113, the CPU 201 determines whether the PC 101 is connected to the Internet and whether the printer 103 has been discovered via the second search. In a case where the PC 101 is connected to the Internet and the printer 103 has been discovered via the second search of step S1110, the CPU 201 proceeds the processing to step S1114. On the other hand, in a case where either the PC 101 is not connected to the Internet or the printer 103 is not discovered via the second search of step S1110, the CPU 201 proceeds the processing to step S1118.

Steps S1114 to S1117 and step S1123 are the same as described for steps S614 to S617 and step S618 of FIG. 6 and thus description thereof will be omitted.

In step S1118, the CPU 201 re-connects the wireless LAN interface 211 to the first network. Note that the establishment of a connection between the wireless LAN interface 211 and the first network is performed while the application for setup is running and via an instruction from the application for setup. Also, at this time, immediately after the connection is disconnected, there is a possibility that the OS is in an unstable state having been unable to search for a surrounding SSID. Thus, there is a possibility of re-connection to the first network failing. Thus, after a certain amount of time has passed since the disconnection of the connection to the second network, the CPU 201 may attempt to re-connect to the first network. Alternatively, in a case where re-connection to the first network fails, attempting to re-connect to the first network may reduce the number of connection failures.

In step S1119, the CPU 201 deletes the wireless profile of the second network stored in the PC 101. Via the processing of step S1119, a wireless profile that may cause an unintentional connection can be prevented from remaining. Note that the wireless profile may be unable to be deleted depending on the OS. In this case, step S1119 is skipped.

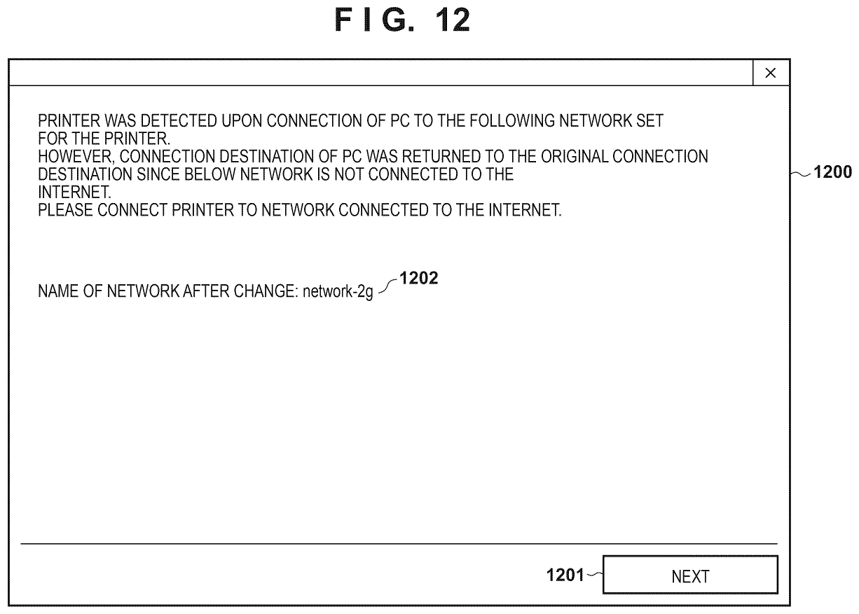

In step S1120, it is determined whether or not the printer 103 is discovered in the second search of step S1110. In a case where it is determined that the printer 103 is not discovered, the CPU 201 proceeds the processing to step S1123. In a case where it is determined that the printer 103 is discovered, in step S1121, the CPU 201 displays a notification screen 1200 illustrated in FIG. 12 on the display apparatus 208. For example, on the notification screen 1200, a message indicating that the printer 103 has been discovered on the second network or a message indicating that the wireless LAN interface 211 has temporarily connected to the second network is displayed. Also, the notification screen 1200 includes a region 1202 for displaying a message indicating that the connection of the wireless LAN interface 211 has been returned to the first network due to the second network not being connected to the Internet and the second SSID. Also, for example, the notification screen 1200 includes a “Next” button 1201 for the user to operate after confirming the content of the message. By the “Next” button 1201 is pressed, the CPU 201 proceeds the processing to step S1123.

Step S1123 is the same as described for step S618 of FIG. 6, and after completion of the processing of step S1123, the printer communication confirmation processing of FIGS. 11A and 11B ends.

As described above, according to the present embodiment, in a case where detection of the printer 103 via the second search of step S1110 is successful but the second network is not able to connect to the Internet, the user is notified that the wireless setup has failed due to the second network not being able to connect to the Internet. Thus, in a case where, for example, the second network cannot connect to the Internet, the user can know that the reason that the wireless setup failed is due to being unable to connect to the Internet. Thus, in a case where the user performs the wireless setup again, the PC 101 connects the printer 103 to an SSID of a network that can connect to the Internet, thus improving user-friendliness.

### Fourth Embodiment

The differences between the fourth embodiment and the first, second, and third embodiment will be described below. In the present embodiment, in a case where the PC 101 cannot connect to the Internet but the printer 103 is discovered via the second search of step S1310 (step S1310 will be described below), a confirmation screen for confirming whether to maintain the second network connection is displayed before the connection destination of the PC 101 is returned to the first network. On the confirmation screen, the user is made to select whether to maintain the connection destination of the PC 101 as the second network. Accordingly, in a case where the user determines that the PC 101 does not need to be connected to the Internet, the wireless setup can be determined a success without returning the connection destination of the PC 101 to the first network, and processing can proceed. Also, in a case where the user determines that the PC 101 needs to be connected to the Internet, the connection destination of the PC 101 can be returned to the first network. Note that in the present embodiment, there is a possibility of maintaining the second network even if there is no Internet connection. Thus, the printer driver used in step S315 of FIG. 3 may be included in with the application for setup.

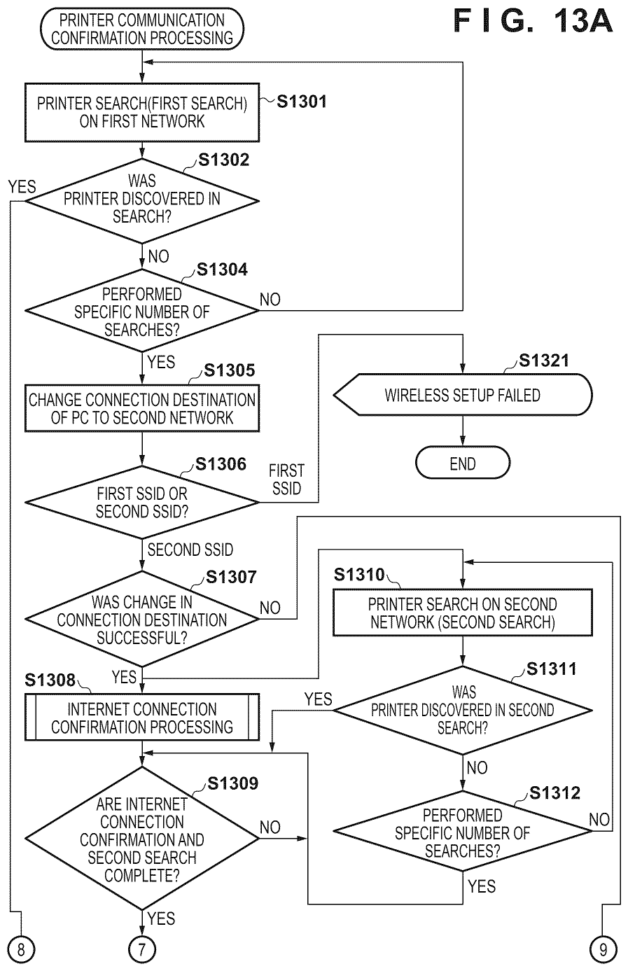

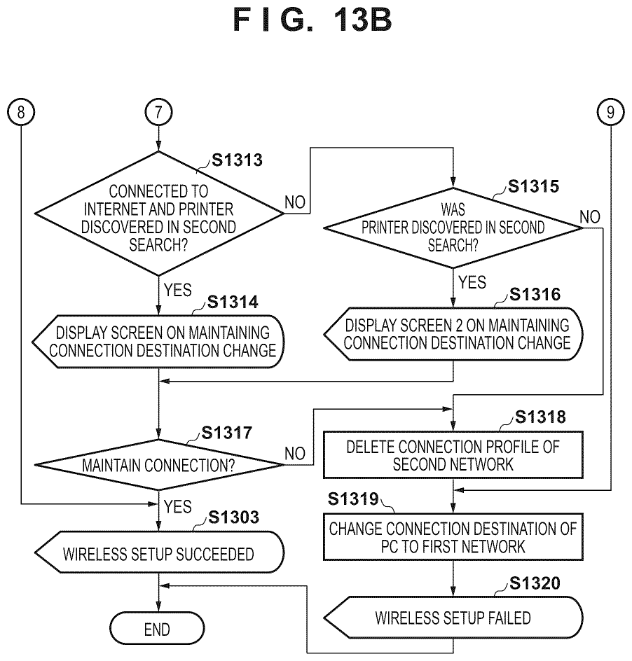

The printer communication confirmation processing of step S313 according to the present embodiment will now be described using FIGS. 13A and 13B. The processing of FIGS. 13A and 13B are implemented by the CPU 201 reading out the program 203 stored in the ROM 202 onto the RAM 206 and executing the program 203, for example. Note that the processing of FIGS. 13A and 13B atre implemented via the application for setup. Also, the processing of FIGS. A and 13B, for example, are started on the basis of the user performing a predetermined instruction on a screen displayed by the application for setup.

Steps S1301 to S1312 and step S1321 are the same as described for steps S601 to S612 and step S619 of FIG. 6 and thus description thereof will be omitted.

In step S1313, the CPU 201 determines whether the PC 101 is connected to the Internet and whether the printer 103 has been discovered via the second search of step S1310. In a case where the PC 101 is connected to the Internet and the printer 103 has been discovered via the second search of step S1310, the CPU 201 proceeds the processing to step S1314. In a case where either the PC 101 is not connected to the Internet or the printer 103 is not discovered via the second search of step S1310, the CPU 201 proceeds the processing to step S1315.

Step S1314 is the same as described for step S614 of FIG. 6 and thus description thereof will be omitted. In step S1315, the CPU 201 determines whether or not the printer 103 has been discovered via the second search of step S1310. In a case where the printer 103 has not been discovered via the second search of step S1310, the processing proceeds to step S1318. In a case where the printer 103 has been discovered via the second search of step S1310, the processing proceeds to step S1316.

Steps S1318 to S1320 are the same as steps S616 to S618 of FIG. 6 and thus description thereof will be omitted.

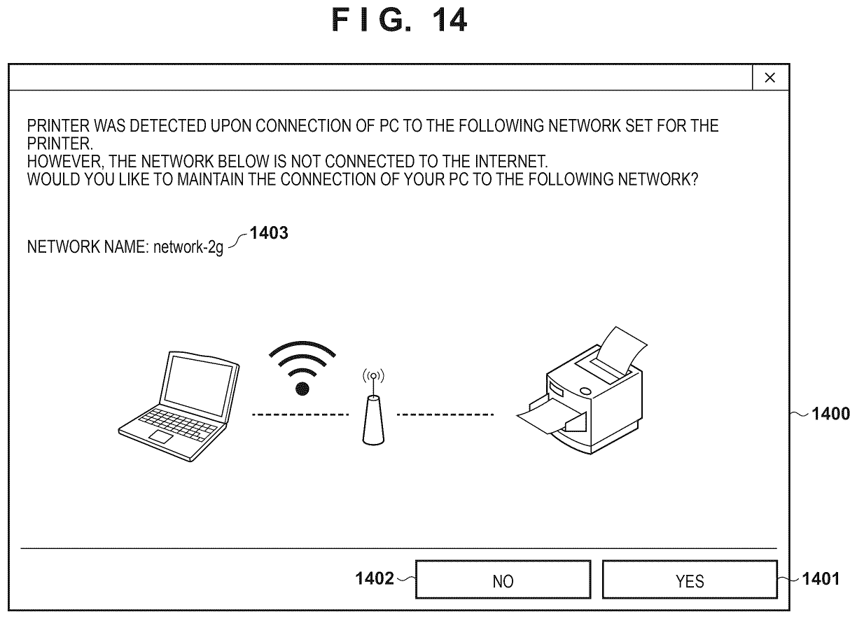

In step S1316, the CPU 201 displays, on the display apparatus 208, a confirmation screen for the user to confirm whether or not to maintain the connection between the changed connection destination network (the second network) and the PC 101. Here, for example, a confirmation screen 1400 illustrated in FIG. 14 is displayed on the display apparatus 208. For example, on the confirmation screen 1400, a message indicating that the printer 103 has been discovered on the second network or a message indicating that the wireless LAN interface 211 has connected to the second network is displayed. Also, the confirmation screen 1400 includes a region 1403 for displaying a message indicating that the PC 101 cannot connect to the Internet and the second SSID. Also, for example, the confirmation screen 1400 includes a “Yes” button 1401 and a “No” button 1402 to be operated by the user according to the content of the message, and the confirmation screen 1400 is a screen for displaying a message for the user to confirm whether or not to maintain the connection to the second network even if the PC 101 cannot connect to the Internet and to prompt the user to press either the “Yes” button 1401 or the “No” button 1402. In other words, the confirmation screen 1400 may be referred to as a selection screen that can receive a user instruction of whether to set the connection destination of the PC 101 to the first network or the second network. Also, in other words, the confirmation screen 1400 is a scream for the user to confirm whether or not to switch the connection destination of the PC 101 to the connection destination network before the change (the first network). In other words, the confirmation screen 1400 is a reception screen that can receive a user instruction of whether or not to maintain the change of the network that the PC 101 belongs to from the first network to the second network.

In step S1317, the CPU 201 determines whether or not to maintain the connection to the second network. Specifically, for example, when the user presses the “Yes” button 1401, in step S1317, the CPU 201 determines to maintain the connection to the second network of the wireless LAN interface 211. Then, in step S1303, the CPU 201 displays the screen 810 illustrated in FIG. 8A on the display apparatus 208. Thereafter, in a case where the end button 811 included on the screen 810 is pressed, the printer communication confirmation processing of FIGS. 13A and 13B ends. In this case, even in a case where an operation to end the printer communication confirmation processing of FIGS. 13A and 13B has been received, the connection to the second network of the wireless LAN interface 211 is maintained. In other words, even if an operation to end the printer communication confirmation processing of FIGS. 13A and 13B, a switch from the second network of the wireless LAN interface 211 to the first network is not performed. On the other hand, in a case where the user presses the “No” button 1402, in step S1314, the CPU 201 determines to not maintain the connection to the second network of the wireless LAN interface 211, and the processing proceeds to step S1318. The processing of step S1318 from here onward is the same as described above.

As described above, according to the present embodiment, in a case where the second search of step S1310 is successful but the second network cannot connect to the Internet, the user is made to select whether or not maintain the connection destination as the second network even though it cannot connect to the Internet. In a case where the user allows no Internet connection, the connection destination of the PC 101 is maintained as the currently connected second network, and the wireless setup is set as complete. On the other hand, in a case where the user does not allow no Internet connection, the connection destination of the PC 101 is returned to the first network. In this manner, the wireless setup is completed only in a case where the user allows there to be no Internet connection. This can improve user-friendliness.

The present disclosure may be implemented by providing a program that implements one or more of the functions of the embodiments described above to a system or a device via a network or a storage medium and the program being read out and executed by one or more processors in a computer of the system or device. Also, the present disclosure may be implemented by a circuit (for example, ASIC) that implements one or more of the functions.

### OTHER EMBODIMENTS

Note that the present disclosure can naturally also be achieved by a storage medium storing a program code for software to implement the functions of the embodiments described above being provided to a system or apparatus, and a computer (or CPU or MPU) of the system or apparatus reading out and executing the program code stored on the storage medium. In this case, the program code read out from the storage medium implements the functions of the embodiments described above, and the storage medium storing the program code constitutes the present disclosure.

Examples of a storage medium that can be used to provide a program code includes a flexible disk, a hard disk, an optical disk, a magneto-optical disk, CD-ROM, CD-R, a magnetic tape, a non-volatile memory card, ROM, a DVD, and the like.

Also, not only can the functions of the embodiments described above be implemented by the computer executing the read program code, but naturally also the functions of the embodiments described above may be implemented by the operating system or the like running on a computer executing a part or all of the actual processing on the basis of an instruction in the program code.

Also, naturally, the functions of the embodiments described above may be implemented by the CPU or the like of a function extension board or a function extension unit executing a part or all of the actual processing on the basis of an instruction in the program code after the program code read from the storage medium is written to a memory of the function extension board inserted in a computer or the function extension unit connected to a computer.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MP)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-087248, filed May 29, 2024, which is hereby incorporated by reference herein in its entirety.

What is claimed is:

1. A control method for an information processing apparatus including a predetermined application program, the control method comprising:
transmitting connection information to a communication apparatus for connecting to an external access point;
executing first processing that is processing for causing the information processing apparatus to execute first search processing for searching for the communication apparatus corresponding to a transmission destination of the connection information on a predetermined network that the information processing apparatus belongs to, and is processing executed by the predetermined application program in a state in which the information processing apparatus belongs to the predetermined network; and
executing second processing that is processing for causing the information processing apparatus to execute confirmation processing for confirming whether or not the information processing apparatus belonging to the predetermined network is connected to an Internet, and is processing executed by the predetermined application program in a state in which the information processing apparatus belongs to the predetermined network, wherein
by the first processing and the second processing being executed by the predetermined application program, control is performed so that the first search processing and the confirmation processing are executed by the information processing apparatus in parallel.

2. The control method according to claim 1, further comprising:
establishing a first connection between the communication apparatus and the information processing apparatus bypassing the external access point, wherein the connection information is transmitted via the first connection.

3. The control method according to claim 2, further comprising:
receiving a list of the external access point discovered by the communication apparatus via a search from the communication apparatus via the first connection, wherein
in a case where the list includes the external access point that the information processing apparatus was connected to before the first connection was established, as the connection information, information for connecting to the external access point that the information processing apparatus was connected to before the first connection was established is transmitted to the communication apparatus, and in a case where the list does not include the external access point that the information processing apparatus was connected to before the first connection was established, as the connection information, information for connecting to the external access point selected from the list is transmitted to the communication apparatus.

4. The control method according to claim 2, wherein
the first connection is disconnected after the connection information is transmitted via the first connection,
a second connection between the information processing apparatus and the external access point is established after the first connection is disconnected, and
the first search processing and the confirmation processing are executed in parallel after the second connection is established.

5. The control method according to claim 4, wherein
the second connection is a connection between the information processing apparatus and a first external access point that the information processing apparatus was connected to before the first connection was established.

6. The control method according to claim 5, further comprising:
executing second search processing for searching for the communication apparatus corresponding to a transmission destination of the connection information on a network that the information processing apparatus belongs to in a case where the second connection is established; and
establishing a third connection between the information processing apparatus and a second external access point, which is an external access point corresponding to the connection information transmitted to the communication apparatus on a basis of the communication apparatus not being discovered via the second search processing and an external access point different from the first external access point that the information processing apparatus was connected to before the first connection was established, wherein
the first search processing and the confirmation processing are executed in parallel after the third connection is established, and
a network of the second external access point is the predetermined network.

7. The control method according to claim 6, wherein
in a case where the communication apparatus is discovered via the second search processing, the third connection is not established and the first search processing and the confirmation processing are not executed.

8. The control method according to claim 6, wherein
in a case where the communication apparatus is not discovered via the second search processing, but information for connecting to the first external access point is transmitted to the communication apparatus as the connection information, the first search processing and the confirmation processing are not executed, and
in a case where the communication apparatus is not discovered via the second search processing and information for connecting to the second external access point is transmitted to the communication apparatus as the connection information, the third connection is established and, after the third connection is established, the first search processing and the confirmation processing are executed in parallel.

9. The control method according to claim 6, further comprising:
displaying a first confirmation screen for a user to confirm whether to maintain a connection destination of the information processing apparatus as the second external access point in a case where the communication apparatus is discovered via the first search processing and the information processing apparatus is confirmed to be connected to an Internet via the confirmation processing; and
maintaining a connection destination of the information processing apparatus as the second external access point in a case where an input is performed on the first confirmation screen indicating to maintain a connection destination of the information processing apparatus as the second external access point, and changing a connection destination of the information processing apparatus to the first external access point in a case where an input is performed on the first confirmation screen indicating not to maintain a connection destination of the information processing apparatus as the second external access point.

10. The control method according to claim 6, further comprising:
changing a connection destination of the information processing apparatus to the first external access point in a case where the communication apparatus is not discovered via the first search processing or the information processing apparatus is not confirmed to be connected to an Internet via the confirmation processing.

11. The control method according to claim 6, further comprising:
displaying a second confirmation screen for a user to confirm whether to maintain a connection destination of the information processing apparatus as the second external access point in a case where the communication apparatus is discovered via the first search processing but the information processing apparatus is not confirmed to be connected to an Internet via the confirmation processing; and
maintaining a connection destination of the information processing apparatus as the second external access point in a case where an input is performed on the second confirmation screen indicating to maintain a connection destination of the information processing apparatus as the second external access point, and changing a connection destination of the information processing apparatus to the first external access point in a case where an input is performed on the second confirmation screen indicating not to maintain a connection destination of the information processing apparatus as the second external access point.

12. The control method according to claim 11, wherein
the second confirmation screen includes a region for indicating that the information processing apparatus is not connected to an Internet.

13. The control method according to claim 1, wherein
the confirmation processing includes processing for downloading a specific file from an external server and processing for determining whether or not download of the specific file has been successful, and
in a case where the information processing apparatus is connected to an Internet, download of the specific file is successful, and in a case where the information processing apparatus is not connected to an Internet, download of the specific file is a failure.

14. The control method according to claim 13, wherein
the specific file is information relating to a model of the communication apparatus.

15. The control method according to claim 13, further comprising:
executing processing to download the specific file from the external server as processing different from the confirmation processing.

16. The control method according to claim 1, wherein
timing of when to start the first search processing and timing of when to start the confirmation processing is the same or different.

17. The control method according to claim 1, wherein
timing of when to end the first search processing and timing of when to end the confirmation processing is the same or different.

18. The control method according to claim 1, wherein
the communication apparatus is a printing apparatus.

19. An information processing apparatus including a predetermined application program, the information processing apparatus comprising:
at least one memory and at least one processor which function as:
a transmitting unit configured to transmit connection information to a communication apparatus for connecting to an external access point;
a first processing unit configured to execute first processing that is processing for causing the information processing apparatus to execute first search processing for searching for the communication apparatus corresponding to a transmission destination of the connection information on a predetermined network that the information processing apparatus belongs to, and is processing executed by the predetermined application program in a state in which the information processing apparatus belongs to the predetermined network; and
a second processing unit configured to execute second processing that is processing for causing the information processing apparatus to execute confirmation processing for confirming whether or not the information processing apparatus belonging to the predetermined network is connected to an Internet, and is processing executed by the predetermined application program in a state in which the information processing apparatus belongs to the predetermined network, wherein
by the first processing and the second processing being executed by the predetermined application program, control is performed so that the first search processing and the confirmation processing are executed by the information processing apparatus in parallel.

20. A non-transitory computer-readable storage medium storing a predetermined application program configured to be executed by one or more processors of an information processing apparatus, the predetermined application program including instructions to cause the information processing apparatus to:
transmit connection information to a communication apparatus for connecting to an external access point;
execute first processing that is processing for causing the information processing apparatus to execute first search processing for searching for the communication apparatus corresponding to a transmission destination of the connection information on a predetermined network that the information processing apparatus belongs to, and is processing executed by the predetermined application program in a state in which the information processing apparatus belongs to the predetermined network; and
execute second processing that is processing for causing the information processing apparatus to execute confirmation processing for confirming whether or not the information processing apparatus belonging to the predetermined network is connected to an Internet, and is processing executed by the predetermined application program in a state in which the information processing apparatus belongs to the predetermined network, wherein
by the first processing and the second processing being executed by the predetermined application program, control is performed so that the first search processing and the confirmation processing are executed by the information processing apparatus in parallel.
